(19) United States
(12) Patent Application Publication
(10) Pub. No.: US 2026/0220922 A1
(43) Pub. Date: Jul. 30, 2026

(54) ELECTRONIC DEVICE AND OPERATION METHOD THEREOF

(71) Applicant: Samsung Electronics Co., Ltd., Suwon-si (KR)

(72) Inventors: Jinsol PARK, Suwon-si (KR); Minkyo SEO, Suwon-si (KR); Suho CHO, Suwon-si (KR); Jeongrok JANG, Suwon-si (KR); Junghee KIM, Suwon-si (KR)

(21) Appl. No.: 19/547,213

(22) Filed: Feb. 23, 2026

Related U.S. Application Data
(63) Continuation of application No. PCT/KR2026/001518, filed on Jan. 26, 2026.

(30) Foreign Application Priority Data
Jan. 24, 2025 (KR) 10-2025-0011883

(51) Int. Cl. G06V 10/774; G06V 10/776; G06V 10/94

(52) U.S. Cl. CPC G06V 10/774; G06V 10/776; G06V 10/95

(57) ABSTRACT

An electronic device may identify, based on a content image input thereto, one or more objects through each of a first artificial intelligence (AI) model and a second AI model, and when the identified objects do not correspond to each other, transmit, to a server, the content image and information corresponding to the identified one or more objects.

### CROSS-REFERENCE TO RELATED APPLICATIONS

This application is a continuation of International Application No. PCT/KR2026/001518 designating the United States, filed on January 26, 2026, in the Korean Intellectual Property Receiving Office and claiming priority to Korean Patent Application No. 10-2025-0011883, filed on January 24, 2025, in the Korean Intellectual Property Office, the disclosures of each of which are incorporated by reference herein in their entireties.

### BACKGROUND

### FIELD

The disclosure relates to an electronic device and an operation method of the electronic device, a server and an operation method of the server, a system including the electronic device and the server, a computer-readable recording medium having stored therein a computer program for performing the operation method of the electronic device, and a computer-readable recording medium having stored therein a computer program for performing the operation method of the server.

### DESCRIPTION OF RELATED ART

In the fields of image processing and computer vision, artificial intelligence (AI) has enabled a high level of performance improvement that was previously impossible. However, AI-based image processing algorithms have had limitations in that they require a high amount of computation. Recently, with the lightweight design of such image processing algorithms and improvement and optimization in the performance of hardware for executing computation of the image processing algorithms, it has been possible to realize an on-device method for performing AI-based image processing within a device. The on-device method refers to a method of running AI-based algorithms directly on the device itself, such as a smartphone, a tablet, an Internet of Things (IoT) device, or the like, rather than on a cloud server.

There may be a difference between a dataset used for training at the time of development of an on-device model and a dataset actually provided when the on-device model is actually deployed and run directly within a device. Accordingly, research has been conducted to address performance degradation due to a difference in datasets even when an on-device model is run directly within the device.

### SUMMARY

According to an embodiment of the disclosure, an electronic device may be provided.

According to an example embodiment of the disclosure, the electronic device may include: a communication interface including communication circuitry; memory storing a plurality of instructions; and at least one processor, comprising processing circuitry, operatively coupled to the memory.

According to an example embodiment of the disclosure, the plurality of instructions, when executed by the at least one processor, individually and/or collectively, may cause the electronic device to: identify, based on a content image input to the electronic device, one or more objects through each of a first artificial intelligence (AI) model and a second AI model.

According to an embodiment of the disclosure, the plurality of instructions, when executed by the at least one processor individually or collectively, may cause the electronic device to, based on the one or more objects identified through the first AI model not corresponding to the one or more objects identified through the second AI model, transmit, to a server, via the communication interface, the content image, information corresponding to the one or more objects identified through the first AI model, and information corresponding to the one or more objects identified through the second AI model.

According to an embodiment of the disclosure, the plurality of instructions, when executed by the at least one processor individually or collectively, may cause the electronic device to receive, from the server, via the communication interface, information corresponding to an update of at least one of the first AI model or the second AI model, obtained using a training image generated based on the content image, the information corresponding to the one or more objects identified through the first AI model, and the information corresponding to the one or more objects identified through the second AI model.

According to an embodiment of the disclosure, a method of operating an electronic device may be provided.

According to an example embodiment of the disclosure, the method of operating the electronic device may include identifying, based on a content image input to the electronic device, one or more objects through each of a first AI model and a second AI model.

According to an example embodiment of the disclosure, the operation method of the electronic device may include based on the one or more objects identified through the first AI model not corresponding to the one or more objects identified through the second AI model, transmitting, to a server, the content image, information corresponding to the one or more objects identified through the first AI model, and information corresponding to the one or more objects identified through the second AI model.

According to an example embodiment of the disclosure, the operation method of the electronic device may include receiving, from the server, information corresponding to an update of at least one of the first AI model or the second AI model, obtained using a training image generated based on the content image, the information corresponding to the one or more objects identified through the first AI model, and the information corresponding to the one or more objects identified through the second AI model.

According to an example embodiment of the disclosure, there may be provided a non-transitory computer-readable recording medium having recorded thereon a program for performing any one of the methods of an electronic device, as described above and below.

### BRIEF DESCRIPTION OF THE DRAWINGS

The above and other aspects, features and advantages of an embodiment of the present disclosure will be more apparent from the following detailed description, taken in conjunction with the accompanying drawings in which reference numerals denote structural elements and in which:

FIG. 1 is a diagram illustrating an example operation of receiving, from a server, update information about a model stored in an electronic device, according to various embodiments;

FIG. 2 is a flowchart illustrating an example method of operating an electronic device, according to various embodiments;

FIG. 3 is a flowchart illustrating an example method of operating a server, according to various embodiments;

FIG. 4 is a signal flow diagram illustrating an example method of operating a system, according to various embodiments;

FIG. 5A is a block diagram illustrating an example configuration of an electronic device according to various embodiments;

FIG. 5B is a block diagram illustrating an example configuration of a server, according to various embodiments;

FIG. 5C is a block diagram illustrating an example configuration of a system according to various embodiments;

FIG. 6A is a flowchart illustrating an example operation, performed by an electronic device, of transmitting to a server content images and information about objects identified through models, according to various embodiments;

FIG. 6B is a diagram illustrating an example operation, performed by electronic device, of transmitting to a server a content image and information about objects identified through models, according to various embodiments;

FIG. 7A is a flowchart illustrating an example operation, performed by an electronic device, of transmitting to a server a content image and information about objects identified through models, according to various embodiments;

FIG. 7B is a diagram illustrating an example operation, performed by an electronic device, of transmitting to a server a content image and information about objects identified through models, according to various embodiments;

FIG. 8A is a flowchart illustrating an example operation, performed by a server, of generating a training image, according to various embodiments;

FIG. 8B is a flowchart illustrating an example operation, performed by a server, of generating a training image, according to various embodiments;

FIG. 8C is a diagram illustrating an example operation, performed by a server, of generating a training image, according to various embodiments;

FIG. 9A is a flowchart illustrating an example operation, performed by a server, of determining an identification difficulty level of each of a content image and a training image and storing the training image, according to various embodiments;

FIG. 9B is a diagram illustrating an example operation, performed by a server, of determining an identification difficulty level of each of a content image and a training image and storing the training image, according to various embodiments;

FIG. 9C is a diagram illustrating an example operation, performed by a server, of determining an identification difficulty level of each of a content image and a training image and storing the training image, according to various embodiments;

FIG. 10A is a flowchart illustrating an example operation, performed by a server, of training a model, according to various embodiments;

FIG. 10B is a flowchart illustrating an example operation, performed by a server, of training a model, according to various embodiments;

FIG. 10C is a diagram illustrating an example operation, performed by a server, of training a model, according to various embodiments;

FIG. 11A is a flowchart illustrating an example operation, performed by a server, of distributing models to multiple electronic devices, according to various embodiments;

FIG. 11B is a diagram illustrating an example operation, performed by a server, of distributing models to multiple electronic devices, according to various embodiments;

FIG. 12A is a flowchart illustrating an example operation, performed by an electronic device, of training a model, according to various embodiments;

FIG. 12B is a diagram illustrating an example operation, performed by an electronic device, of training a model, according to various embodiments; and

FIG. 13 is a block diagram illustrating an example configuration of an electronic device according to various embodiments.

### DETAILED DESCRIPTION

Throughout the disclosure, the expression "at least one of a, b or c" indicates only a, only b, only c, both a and b, both a and c, both b and c, all of a, b, and c, or variations thereof.

Various example embodiments of the disclosure will be described more fully hereinafter with reference to the accompanying drawings. However, the disclosure may be implemented in different forms and should not be understood as being limited to any embodiment(s) set forth herein.

The terms used in the disclosure are general terms currently widely used in the art by taking into account functions described herein, but may refer to various other terms depending on an intention of skilled persons in the related art, precedent cases, advent of new technologies, etc. Thus, the terms used herein should be defined not by simple appellations thereof but based on the meaning of the terms together with the overall description of the disclosure.

In addition, the terms used herein are only used to describe various embodiments, and are not intended to limit the disclosure.

Throughout the disclosure of the disclosure, it will be understood that when a part is referred to as being "connected" or "coupled" to another part, it may be "directly connected" to or "electrically coupled" to the other part with one or more intervening elements therebetween.

The use of the terms "the" and similar referents used in the disclosure, especially in the following claims, are to be construed to cover both the singular and the plural. Furthermore, operations of a method according to the disclosure described herein may be performed in any suitable order unless the order of the operations is clearly specified herein. The disclosure is not limited to the described order of the operations.

Expressions such as "in some embodiments of the disclosure" or "in an embodiment of the disclosure" described in various parts of this disclosure do not necessarily refer to the same embodiment(s).

Various embodiments of the disclosure may be described in terms of functional block components and various processing operations. Some or all of such functional blocks may be implemented by any number of hardware and/or software components that execute specific functions. For example, functional blocks of the disclosure may be implemented by one or more microprocessors or by circuit components for performing defined (e.g., specified, predefined, or (pre)determined) functions. Furthermore, for example, functional blocks of the disclosure may be implemented in various programming or scripting languages. The functional blocks may be implemented using various algorithms executed by one or more processors. Furthermore, the disclosure may employ techniques of the related art for electronics configuration, signal processing, and/or data processing. The terms such as "mechanism", "element", "means", and "construction" may be used in a broad sense and are not limited to mechanical or physical components.

Connecting lines or connectors shown in various figures are intended to represent example functional relationships and/or physical or logical couplings between components in the figures. In an actual device, connections between components may be represented by various alternative or additional functional relationships, physical connections, or logical connections.

As used herein, the term "unit" or "module" indicates a unit for processing at least one function or operation and may be implemented using hardware or software or a combination of hardware and software.

In the disclosure, a "processor" may include various types of processing circuitry and/or a plurality of processors. For example, the term "processor" as used herein, including that in the claims, may include various types of processing circuitry including at least one processor. One or more of the at least one processor, individually and/or collectively in a distributed form, may be configured to perform various functions described herein. As used herein, "a processor," "at least one processor," and "one or more processors" may be configured to perform various functions. However, these terms cover, without limitation, situations in which one processor performs some of recited functions and another processor (other processors) perform other functions, as well as situations in which a single processor may perform all of the recited functions. Furthermore, the at least one processor may include a combination of processors that perform various functions among the recited functions in a distributed manner. The at least one processor may execute program instructions to accomplish or perform various functions.

In the disclosure, artificial intelligence (AI) technology may include machine learning (deep learning) technology that uses algorithms for classifying/learning the characteristics of input data on their own, and element technologies that simulate functions of a human brain such as cognition, decision-making, etc. by utilizing machine learning algorithms. Element technologies may include, for example, at least one of linguistic understanding technology that recognizes human language/characters, visual understanding technology that recognizes objects as perceived by human eyes, inference/prediction technology that analyzes information and makes logical inferences and predictions, knowledge representation technology that processes human experience information into knowledge data, or motion control technology that controls autonomous driving of vehicles and the movements of robots. Linguistic understanding is a technology for recognizing and applying/processing human language/characters, and may include natural language processing, machine translation, conversational systems, question answering, speech recognition/synthesis, etc. Visual understanding is a technology for recognizing and processing objects as seen by human eyes, and may include object recognition, object tracking, image search, person recognition, scene understanding, spatial understanding, image enhancement, etc. Inference and prediction is a technology for making logical inferences and predictions by analyzing information, and may include knowledge/probability-based inference, optimization prediction, preference-based planning, recommendations, etc. Knowledge representation is a technology for automatically processing human experience information into knowledge data, and may include knowledge construction (data generation/classification), knowledge management (data utilization), etc.

The predefined operation rules or AI model may be created via a training process. In this case, the creation via the training process may refer, for example, to the predefined operation rules or AI model set to perform desired characteristics (or purposes) being created by training a base AI model based on a large number of training data via a learning algorithm. The training process may be performed on a device itself on which AI is performed according to the disclosure, or via a separate server and/or system. Examples of a learning algorithm may include, but are not limited to, supervised learning, unsupervised learning, semi-supervised learning, and reinforcement learning.

An AI model may include a plurality of neural network layers. Each of the plurality of neural network layers may have a plurality of weight values and may perform neural network computations via calculations between a result of computations in a previous layer and the plurality of weight values. The plurality of weight values assigned to each of the plurality of neural network layers may be optimized by a result of training the AI model. For example, the plurality of weight values may be updated to reduce or minimize a loss or cost value obtained in the AI model during a training process. An artificial neural network may include a deep neural network (DNN), and may be, for example, but is not limited to, a convolutional neural network (CNN), a DNN, a recurrent neural network (RNN), a restricted Boltzmann machine (RBM), a deep belief network (DBN), a bidirectional recurrent DNN (BRDNN), or deep Q-networks (DQNs).

Hereinafter, the disclosure is described in greater detail with reference to the accompanying drawings.

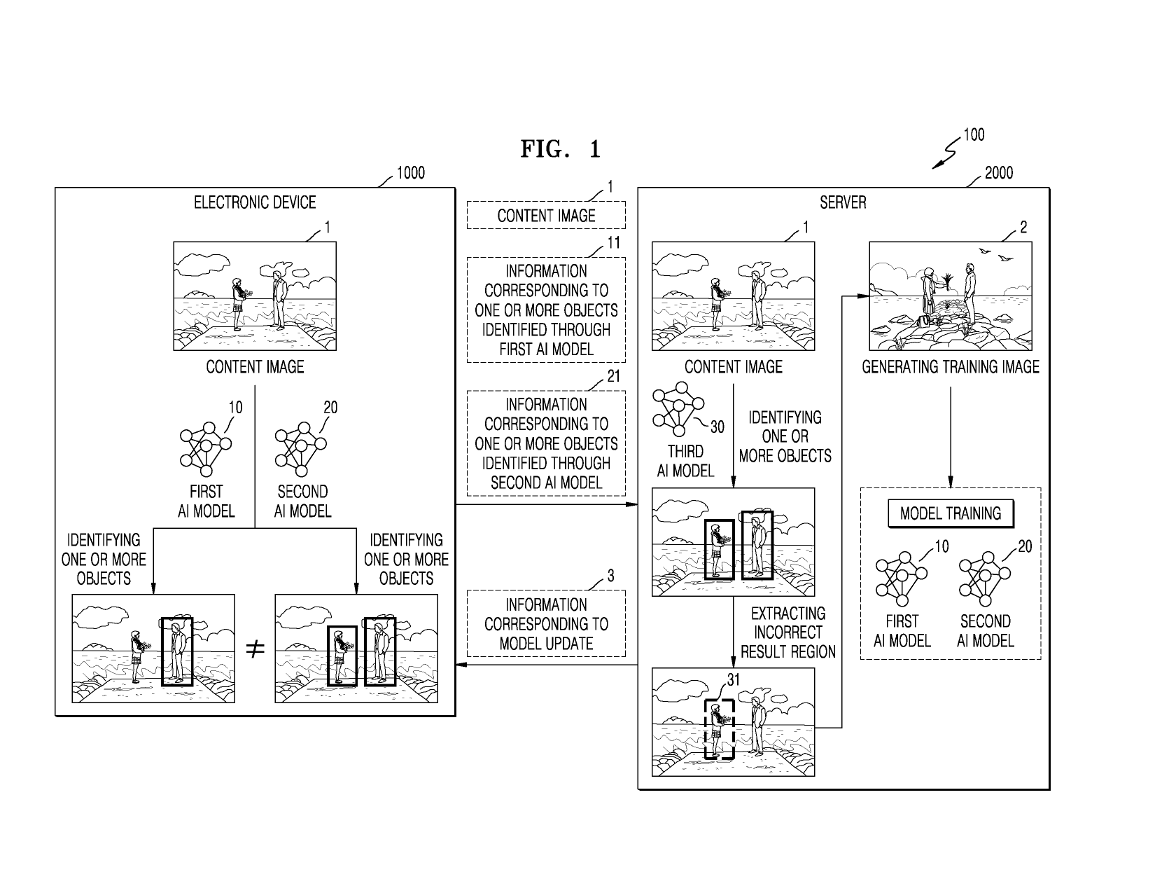

FIG. 1 is a diagram illustrating an example operation of receiving update information about models stored in an electronic device 1000 from a server 2000 within a system 100, according to various embodiments.

Referring to FIG. 1, according to an embodiment of the disclosure, the system 100 may include the at least one electronic device 1000 and the server 2000. Although FIG. 1 illustrates only one electronic device 1000 for convenience of description, the system 100 may include a plurality of electronic devices 1000. In other words, the server 2000 may transmit and receive data to and from the plurality of electronic devices 1000.

According to an embodiment of the disclosure, in the system 100, when it is identified that the electronic device 1000 has obtained incorrect result data through at least one model stored in the electronic device 1000, the electronic device 1000 may transmit information related to the incorrect result data to the server 2000. According to an embodiment of the disclosure, in the system 100, the server 2000 may generate a training image 2 corresponding to a content image 1, based on the information received from the electronic devices 1000. The server 2000 may transmit, to the electronic device 1000, information 3 corresponding to an update of the at least one model stored in the electronic device 1000, which is obtained using the training image 2.

According to an embodiment of the disclosure, the electronic device 1000 may be implemented as various types and forms of electronic devices 1000 including displays. Examples of the electronic device 1000 may include, but are not limited to, devices capable of displaying information on a display, such as a smart television (TV), a smartphone, a tablet personal computer (PC), a personal digital assistant (PDA), a laptop PC, an eyeglass-type display, and a head-mounted display (HMD). For example, the electronic device 1000 may be implemented as various types and forms of electronic devices 1000 that are to be connected to a display by wire or wirelessly. For example, the electronic device 1000 may include, but is not limited to, devices that are connected to a display by wire or wirelessly and capable of displaying information on the display, such as a set-top box, a desktop PC, etc.

In an embodiment of the disclosure, the electronic device 1000 may obtain the content image 1. In this case, the content image 1 may be a still image at a specific time point among time-series images of content provided via the electronic device 1000. Here, "content" may refer to various forms of materials that may be executed by the electronic device 1000 and provided to a user as images or sounds, such as movies, dramas, animations, applications, novels, comic books, advertisements, or web pages. For example, when the electronic device 1000 receives an input regarding an object detection request, the electronic device 1000 may obtain a still image at a time point when the input is received from among the time-series images of the provided content.

The electronic device 1000 may store at least one model for recognizing one or more objects from an input image. In other words, the electronic device 1000 may be equipped with at least one model for identifying an object. In the disclosure, an 'object' may refer to a specific object in an image (or video), and may be classified by class. For example, people, animals, objects, natural objects, buildings, etc. in an image (or video) may be objects. In an embodiment of the disclosure, an object may also include a specific region of a specific object. For example, the object may include a person's face.

In an embodiment of the disclosure, the electronic device 1000 may store a first AI model 10 and a second AI model 20. In the disclosure, the first AI model 10 may also be referred to as a first model, and the second AI model 20 may also be referred to as a second model. The first AI model 10 and the second AI model 20 may be AI models that identifies one or more objects in an input image. The first AI model 10 and the second AI model 20 may be different types of AI models.

In an embodiment of the disclosure, the electronic device 1000 may identify at least one object from the content image 1 using the first AI model 10. The electronic device 1000 may identify at least one object from the content image 1 using the second AI model 20. The electronic device 1000 may compare an object identification result generated by the first AI model 10 from the content image 1 with an object identification result generated by the second AI model 20 from the content image 1, and when the two object identification results are identified as being different from each other, the electronic device 1000 may determine that the first AI model 10 and/or the second AI model 20 has detected incorrect result data in identifying the object in the content image 1. When the electronic device 1000 determines that the incorrect result data has been detected by the first AI model 10 and/or the second AI model 20, the electronic device 1000 may transmit information related to the incorrect result data to the server 2000. For example, the information related to the incorrect result data may include the content image 1 in which the incorrect result data is detected, information 11 corresponding to the at least one object identified from the content image 1 through the first AI model 10, and information 21 corresponding to the at least one object identified from the content image 1 through the second AI model 20.

In an embodiment of the disclosure, the server 2000 may receive, from the electronic device 1000, information about the at least one object identified from the content image 1 through the at least one AI model (e.g., the first AI model 10 and the second AI model 20) stored in the electronic device 1000.

In an embodiment of the disclosure, the server 2000 may store at least one model for identifying one or more objects in an input image. In other words, the server 2000 may be equipped with the at least one model for identifying objects. In an embodiment of the disclosure, the server 2000 may store a third AI model 30. In the disclosure, the third AI model 30 may also be referred to as a third model. The third AI model 30 may be an AI model that identifies one or more objects in an input image. The third AI model 30 may be a different type of AI model from the first AI model 10 and the second AI model 20. The server 2000 may be a device with higher computing performance than the electronic device 1000 so that it may perform more calculations faster than the electronic device 1000. Therefore, the model (e.g., the third AI model 30) installed on the server 2000 may have higher performance than the models (e.g., the first AI model 10 and the second AI model 20) installed on the electronic device 1000.

In an embodiment of the disclosure, the server 2000 may identify objects from the content image 1 using the third AI model 30. The server 2000 may compare a result of the third AI model 30 identifying the objects from the content image 1 with the result of each of the first and second AI models 10 and 20 identifying the object therein. The server 2000 may extract, from the content image 1, an incorrect result region 31 corresponding to an object identified differently by the first AI model 10 and the second AI model 20 installed on the electronic device 1000 and the third AI model 30 installed on the server 2000.

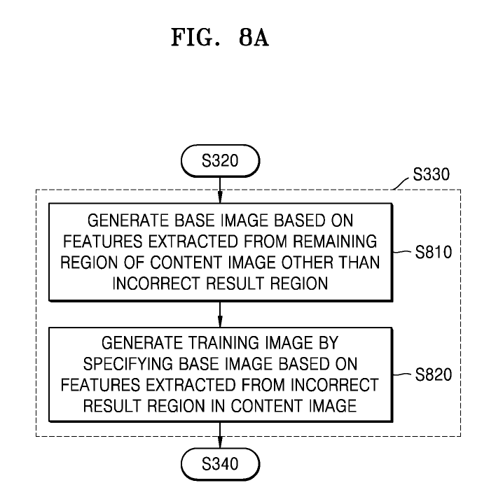

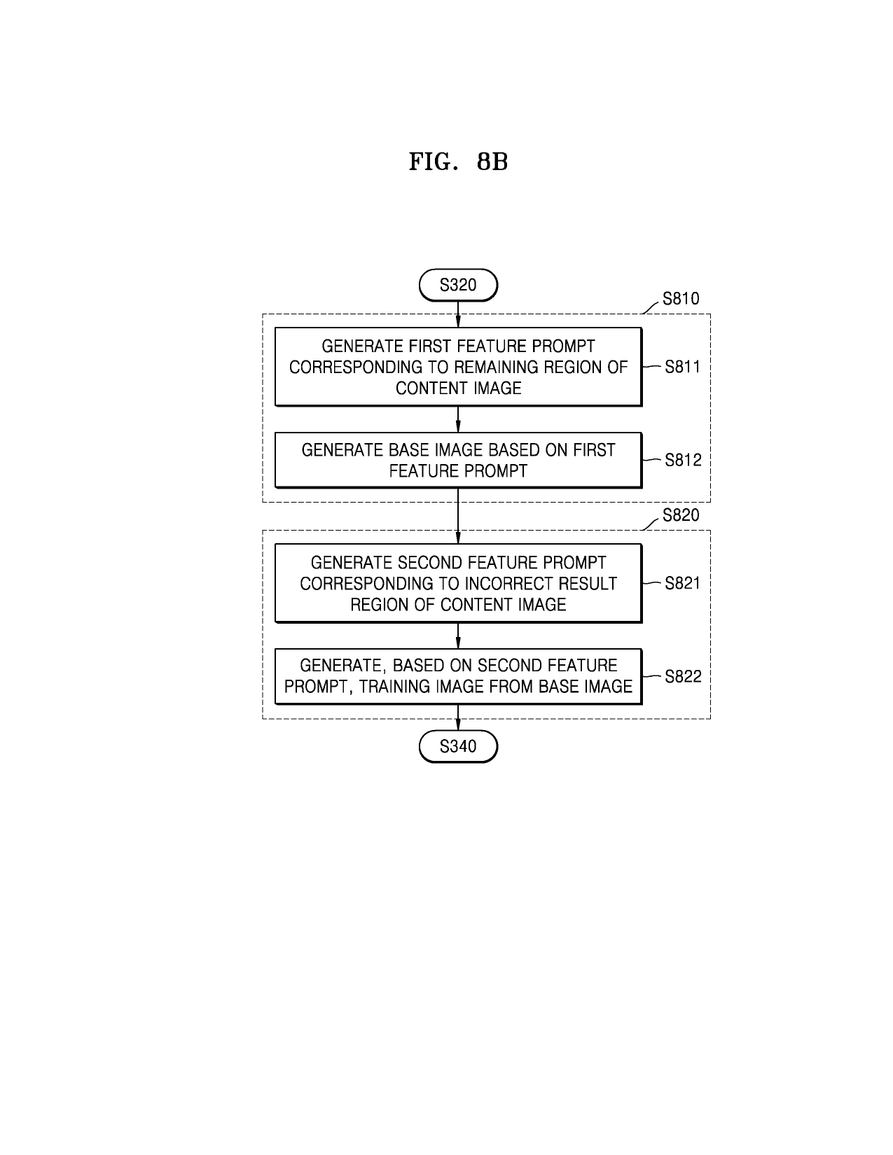

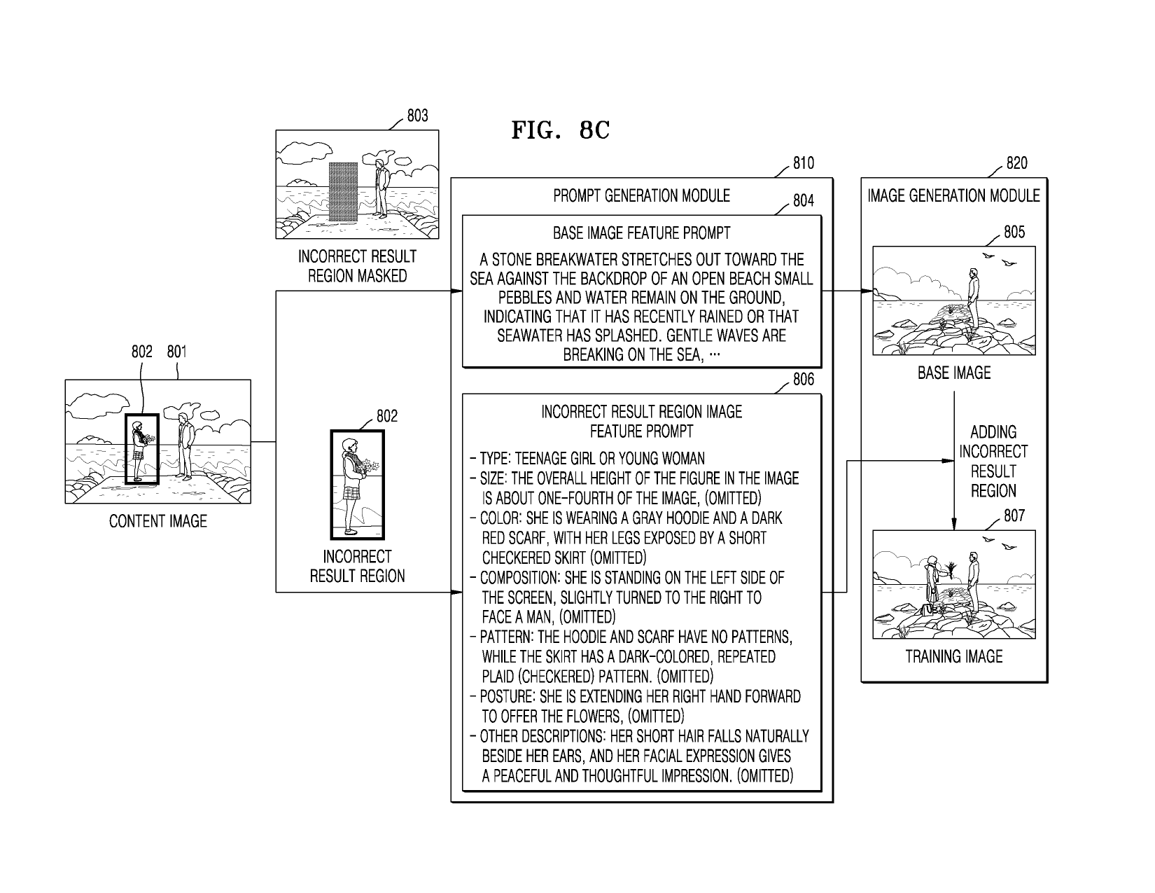

In an embodiment of the disclosure, the server 2000 may generate the training image 2, based on the content image 1 received from the electronic device 1000 and the incorrect result region 31 extracted from the content image 1, and store the generated training image 2. The training image 2 may be an image based on the content image 1 and the incorrect result region 31 corresponding to the object identified differently by the electronic device 1000 and the server 2000. In this case, the server 2000 generates the training image 2 based on the extracted incorrect result region 31 so that the incorrect result region 31 may be represented in a concrete way in the generated training image 2. An operation and a method of generating the training image 2 are described in greater detail below with reference to FIGS. 8A to 8C.

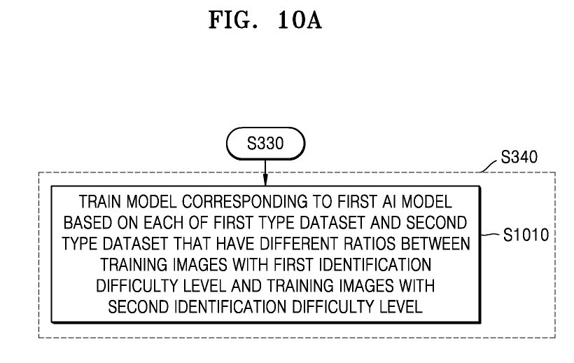

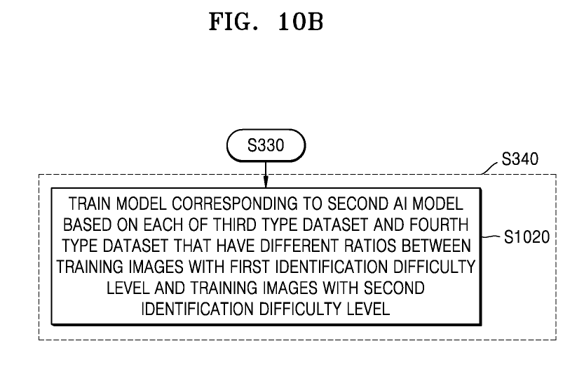

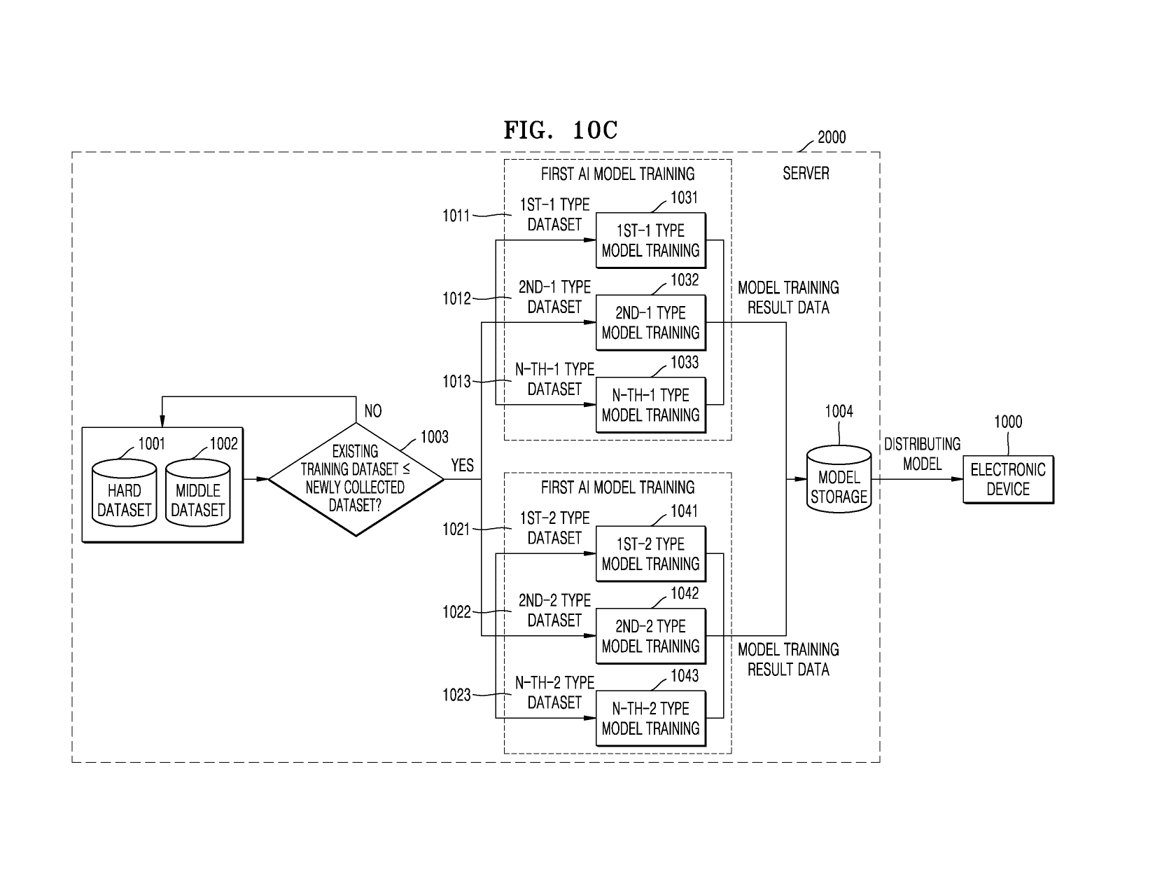

In an embodiment of the disclosure, the server 2000 may train at least one model (e.g., the first AI model 10 and the second AI model 20) stored in the electronic device 1000 using the stored training image 2. The operation and method of performing model training are described in greater detail below with reference to FIGS. 10A to 10C.

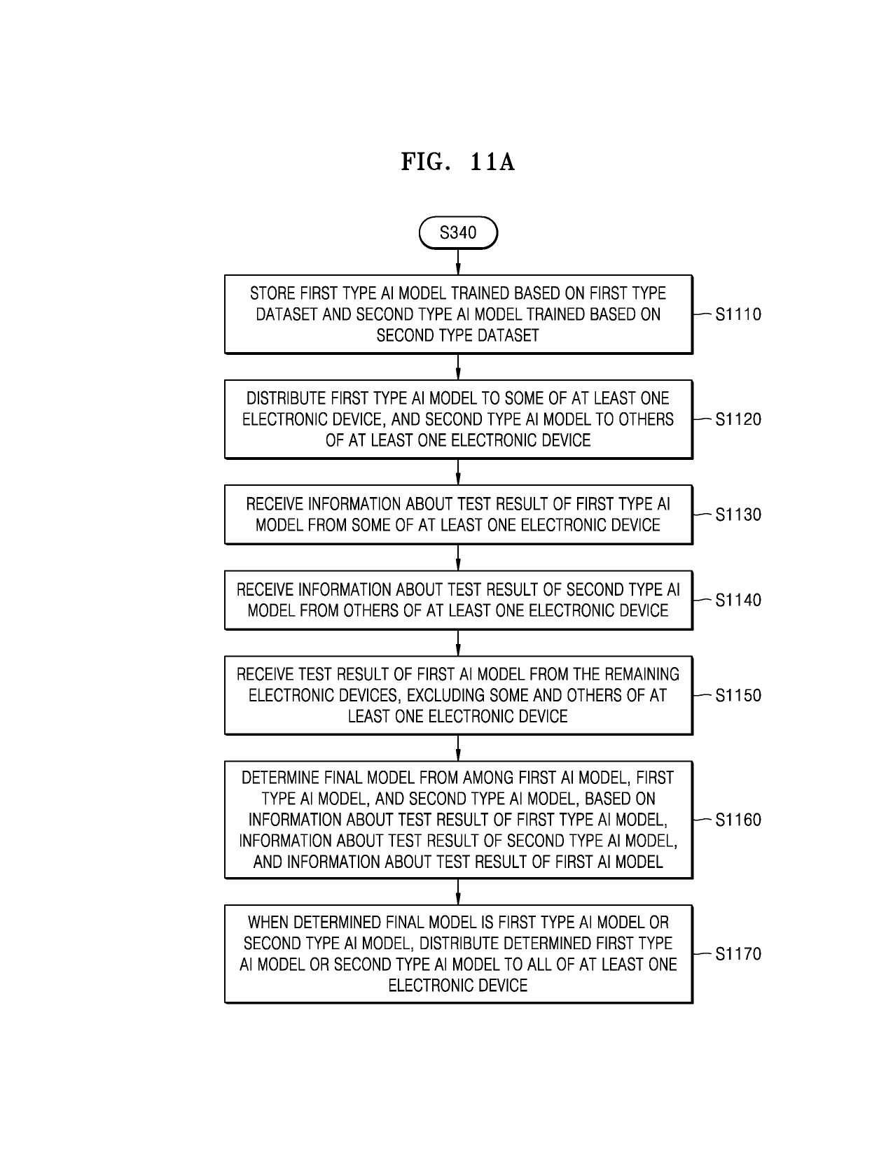

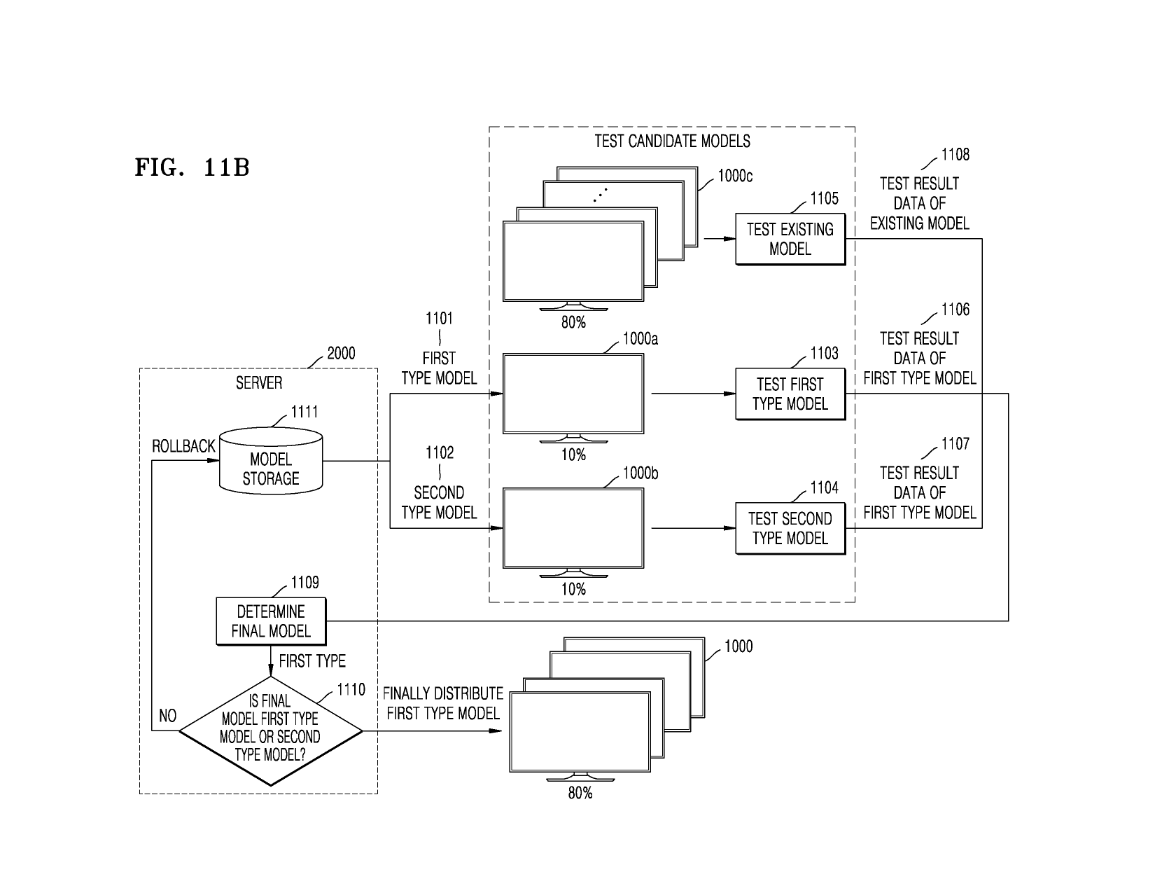

In an embodiment of the disclosure, the server 2000 may receive information corresponding to an update of at least one of the models stored in the electronic device 1000, which is derived by training the at least one model (e.g., the first AI model 10 and the second AI model 20) stored in the electronic device 1000 using the generated training image 2. For example, the information corresponding to the update of the at least one of the models stored in the electronic device 1000 may include at least one of a model that is obtained by updating the first AI model 10 based on the training image 2 or a model that is obtained by updating the second AI model 20 based on the training image 2. An operation and a method of distributing (or updating) a model after training the model are described in greater detail below with reference to FIGS. 11A and 11B.

According to an embodiment of the disclosure, the server 2000 performs model training based on the content image 1 from which incorrect result data is detected in the electronic device 1000, thereby improving the object identification performance of the AI models (e.g., the first and second AI models 10 and 20) installed on the electronic device 1000.

According to an embodiment of the disclosure, the server 2000 may generate the training image 2 based on the content image 1 actually provided by the electronic device 1000, and train the AI models (e.g., the first and second AI models 10 and 20) installed in the electronic device 1000 using the generated training image 2. Accordingly, using the training image 2 generated within the server 2000, the server 2000 may train the first and second AI models 10 and 20 without causing licensing issues such as copyright. On the other hand, a dataset used for training at the time of development of an on-device model may differ from a dataset actually provided at the time when the on-device model is actually distributed to the electronic device 1000 and run directly within the electronic device 1000. However, according to an embodiment of the disclosure, the server 2000 may improve model performance in an actual environment using, when training the first and second AI models 10 and 20, the training image 2 generated based on the content image 1 actually provided by the electronic device 1000.

According to an embodiment of the disclosure, by generating the training image 2 in which the incorrect result region 31 is represented concretely, the server 2000 may perform model training so that an object identification performance in the incorrect result region 31 is improved.

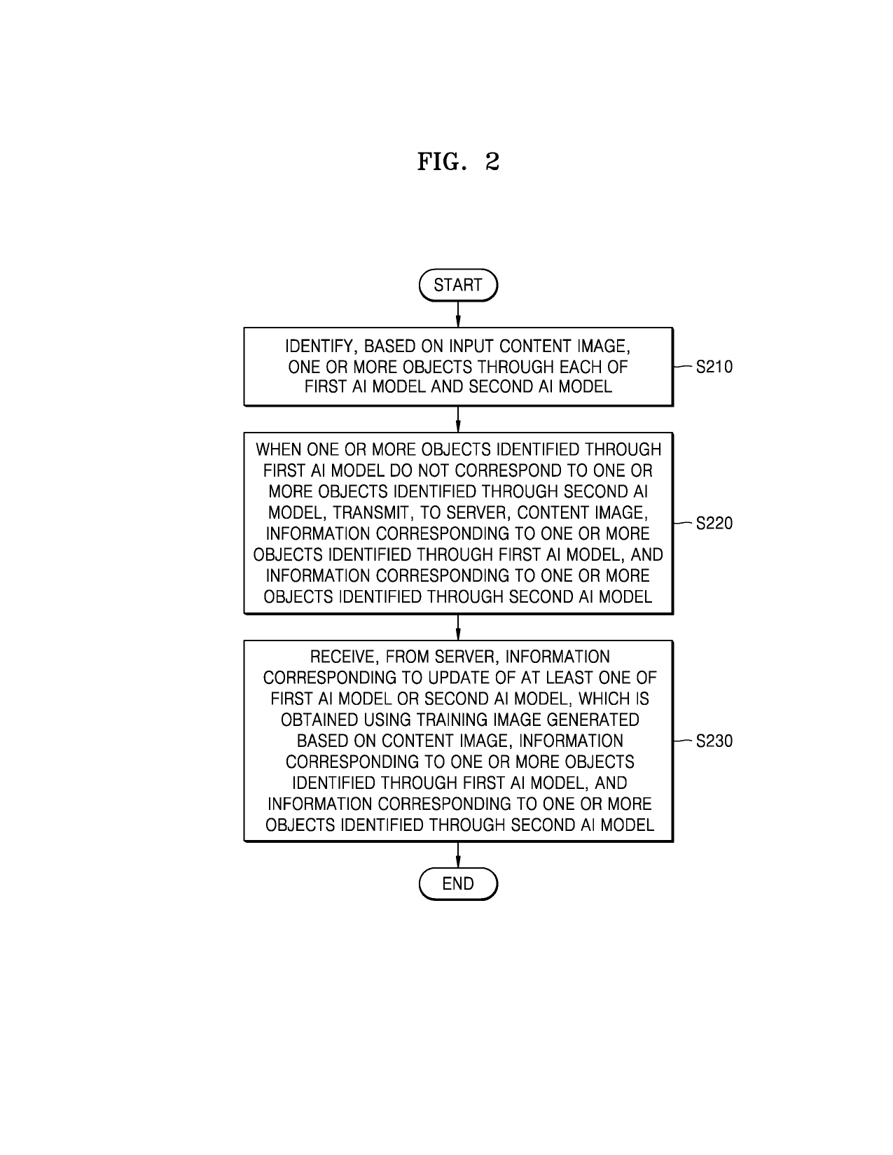

FIG. 2 is a flowchart illustrating an example method of operating the electronic device 1000, according to various embodiments. Hereinafter, the method of operating the electronic device 1000, according to various embodiments, may be described with reference to FIGS. 1 and 2 together.

In operation S210 of FIG. 2, the electronic device 1000 may identify one or more objects based on the input content image 1 through each of the first AI model 10 and the second AI model 20.

In an embodiment of the disclosure, the electronic device 1000 may store a first AI model 10 and a second AI model 20. The first AI model 10 and the second AI model 20 may be AI models that identify one or more objects in an input image. The first AI model 10 and the second AI model 20 may be different types of AI models.

In the disclosure, identifying objects may refer to determining where the objects are located in a given image (object localization) and determining to which category each object belongs (object classification). In an embodiment of the disclosure, AI models for identifying objects may undergo three operations, e.g., candidate object region (or informative region) selection, feature extraction from each candidate region, and classification of candidate object regions by applying a classifier to the extracted features. Depending on a detection method, localization performance may be improved through post-processing such as bounding box regression.

In an embodiment of the disclosure, the first AI model 10 may be a small model, and the second AI model 20 may be a middle model. In the disclosure, a 'small model' refers to a small AI model, and may refer to a model with a relatively small number of parameters and relatively low computational complexity. In the disclosure, a ‘middle model’ refers to a medium-sized AI model, and may refer to a model with more parameters and higher computational complexity than a small model. Small models may perform faster calculations than middle models, but may provide lower performance than middle models. Middle models may provide higher performance than small models, but may be slower in processing calculations than small models.

In an embodiment of the disclosure, the first AI model 10 may be a small model of a first type, and the second AI model 20 may be a small model of a second type. In other words, the first AI model 10 and the second AI model 20 may both be small models, but may be different types of AI models.

In an embodiment of the disclosure, the electronic device 1000 may obtain the information 11 corresponding to one or more objects identified from the content image 1 through the first AI model 10. The first AI model 10 may take the content image 1 as input, identify the one or more objects in the content image 1, and output the information 11 corresponding to the identified one or more objects. For example, the first AI model 10 may output object class information and object position information as the information 11 corresponding to the one or more objects recognized from the content image 1.

The first AI model 10 may perform an algorithm for detecting, based on an image taken as input, one or more objects in the image. The first AI model 10 may be an AI model pretrained to identify, according to an image taken as input, one or more objects in the image, and output information about the identified one or more objects.

In an embodiment of the disclosure, the electronic device 1000 may obtain the information 21 corresponding to one or more objects identified from the content image 1 through the second AI model 20. The second AI model 20 may take the content image 1 as input, identify the one or more objects in the content image 1, and output the information 21 corresponding to the identified one or more objects. For example, the second AI model 20 may output object class information and object position information as the information 21 corresponding to the one or more objects recognized from the content image 1.

The second AI model 20 may perform an algorithm for detecting, based on an image taken as input, one or more objects in the image. The second AI model 20 may be an AI model pretrained to identify, according to an image taken as input, one or more objects in the image, and output information about the identified one or more objects.

In operation S220 of FIG. 2, when the one or more objects identified through the first AI model 10 do not correspond to the one or more objects identified through the second AI model 20, the electronic device 1000 may transmit, to the server 2000, the content image 1, the information 11 corresponding to the one or more objects identified through the first AI model 10, and the information 21 corresponding to the one or more objects identified through the second AI model 20.

In an embodiment of the disclosure, the electronic device 1000 may compare the information 11 corresponding to the one or more objects identified through the first AI model 10 with the information 21 corresponding to the one or more objects identified through the second AI model 20. For example, when a specific object identified through the second AI model 20 is not identified through the first AI model 10, the electronic device 1000 may identify that the one or more objects identified through the first AI model 10 do not correspond to the one or more objects identified through the second AI model 20. For example, when, for a specific object identified through the second AI model 20, the object is also identified as an object through the first AI model 10 but is identified as belonging to a different class than when identified through the second AI model 20, the electronic device 1000 may identify that the one or more objects identified through the first AI model 10 do not correspond to the one or more objects identified through the second AI model 20.

In operation S230 of FIG. 2, the electronic device 1000 may receive, from the server 2000, information 3 corresponding to an update of at least one of the first AI model 10 or the second AI model 20, which is obtained using a training image generated based on the content image 1, the information 11 corresponding to the one or more objects identified through the first AI model 10, and the information 21 corresponding to the one or more objects identified through the second AI model 20.

In an embodiment of the disclosure, the electronic device 1000 may receive, from the server 2000, the information 3 corresponding to the update of the at least one of the first AI model 10 or the second AI model 20. The first AI model 10 and the second AI model 20 installed on the electronic device 1000 may be trained using the server 2000.

In an embodiment of the disclosure, the information 3 corresponding to the update of the AI model may include information about whether the update of the AI model is necessary and, when the update is identified as being necessary, information about updated parameters. In an embodiment of the disclosure, the information 3 corresponding to the update of the AI model may include information about whether the update of the AI model is necessary and, when the update is identified as being necessary, the AI model itself trained by the server 2000. In this case, the trained AI model itself may be provided in a file format.

In an embodiment of the disclosure, the electronic device 1000 may update the corresponding AI model based on the information 3 corresponding to the update of the at least one of the first AI model 10 or the second AI model 20, which is received from the server 2000.

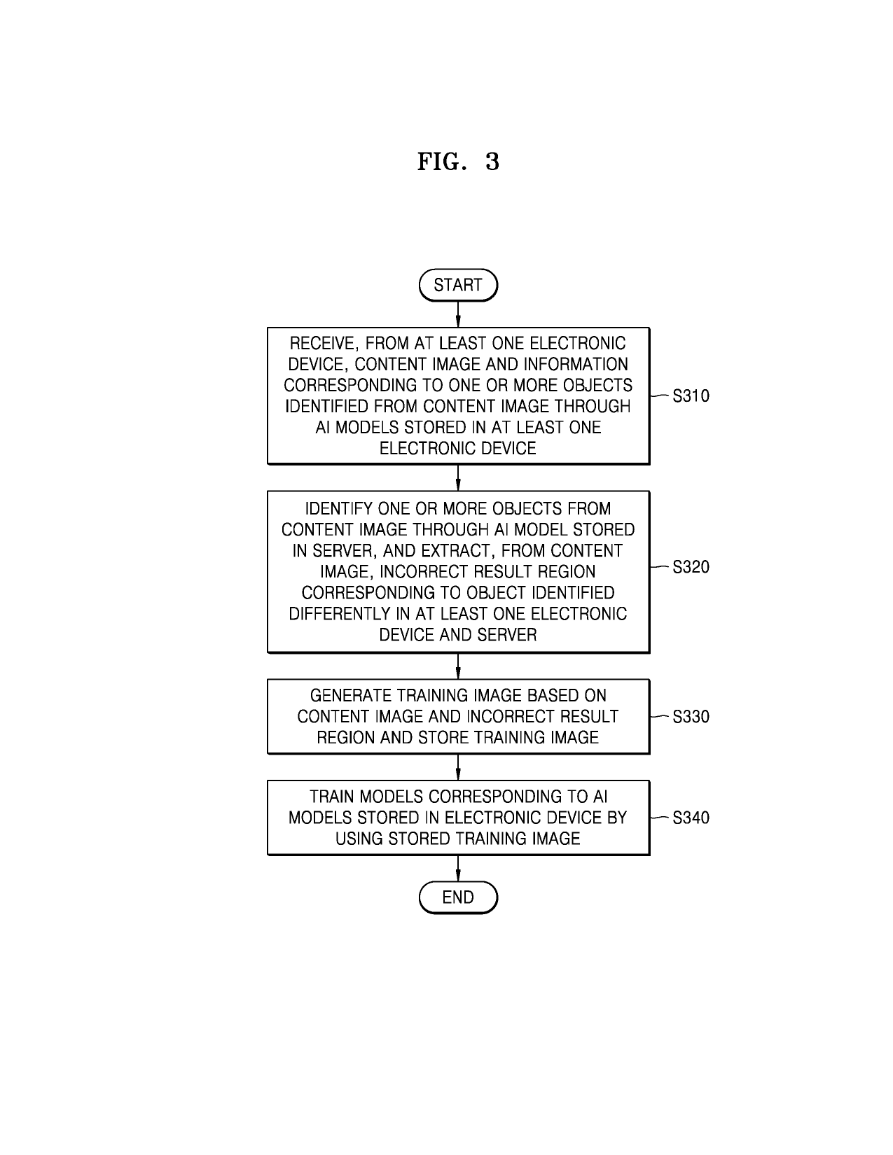

FIG. 3 is a flowchart illustrating an example method of operating the server 2000, according to various embodiments. The method of operating the server 2000, according to various embodiments, is described with reference to FIG. 3 in conjunction with FIG. 1.

In operation S310 of FIG. 3, the server 2000 may receive, from at least one electronic device 1000, the content image 1 and information corresponding to one or more objects identified from the content image 1 through one or more AI models (e.g., the first AI model 10 and/or the second AI model 20) stored in the at least one electronic device 1000.

In an embodiment of the disclosure, when it is determined that incorrect result data has been detected by the one or more AI models stored in the electronic device 1000, the server 2000 may receive, from the at least one electronic device 1000, the content image 1 in which the incorrect result data has been detected and the incorrect result data. In this case, the incorrect result data may include information about one or more objects identified from the content image 1 through the one or more AI models stored in the electronic device 1000 (e.g., the information 11 corresponding to the one or more objects identified through the first AI model 10 and/or the information 21 corresponding to the one or more objects identified through the second AI model 20).

In operation S320 of FIG. 3, the server 2000 may identify one or more objects from the content image 1 through an AI model (or the third AI model 30) stored in the server 2000, and extract, from the content image 1, the incorrect result region 31 corresponding to an object identified differently by the at least one electronic device 1000 and the server 2000.

In an embodiment of the disclosure, the AI model 30 stored in the server 2000 may be a large model. In the disclosure, a 'large model' may refer to a large AI model and may refer to a model with a larger number of parameters and a more complex architecture than a small model and a middle model. The server 2000 may be a device with higher computing performance than the electronic device 1000 so as to be able to perform more calculations faster than the electronic device 1000. Therefore, the AI model (or the third AI model 30) stored in the server 2000 may provide higher performance than the one or more AI models stored in electronic device 1000. For example, the object identification performance of the AI model (e.g., the third AI model 30) stored in the server 2000 may be higher than that of the one or more AI models (e.g., the first and second AI models 10 and 20) stored in the electronic device 1000.

In an embodiment of the disclosure, one or more objects may be identified from the content image 1 using the AI model (or the third AI model 30) stored in the server 2000. When a result of object identification by the AI model (or the third AI model 30) stored in the server 2000 is different from a result of object identification by each of the one or more AI models stored in the electronic device 1000, the result of object identification by the AI model (or the third AI model 30) stored in the server 2000 may be considered as a response (or ground truth). The server 2000 may extract, as the incorrect result region 31, a region corresponding to an object identified differently from the content image 1 by the at least one electronic device 1000 and the server 2000.

In operation S330 of FIG. 3, the server 2000 may generate the training image 2 based on the content image 1 and the incorrect result region 31 and store the training image 2.

In an embodiment of the disclosure, the server 2000 may generate a base image based on the remaining region of the content image 1 other than the incorrect result region 31, and generate the training image 2 by specifying the base image based on the incorrect result region 31 of the content image 1. The training image 2 may correspond to an image obtained by specifying the base image extracted from features extracted from the remaining region of the content image 1 other than the incorrect result region 31, based on features extracted from the incorrect result region 31. Through this, the server 2000 may generate the training image 2 in which the incorrect result region 31 from the content image 1 is depicted in detail.

In operation S340 of FIG. 3, the server 2000 may train models corresponding to the one or more AI models stored in the electronic device 1000 using the stored training image 2.

In an embodiment of the disclosure, the first AI model 10 and the second AI model 20 installed on the electronic device 1000 may be trained using the server 2000. The server 2000 may store a model corresponding to the first AI model 10 and a model corresponding to the second AI model 20. In the disclosure, including, in the server 2000, models corresponding to the AI models installed on the electronic device 1000 may refer to the AI model stored in the server 2000 and the AI models stored in the electronic device 1000 sharing the same architecture and the same weights (or have the same architecture and the same model parameters). For example, the server 2000 may store a model that is the same as the first AI model 10 installed (or stored) on the electronic device 1000. For example, the server 2000 may store a model that is the same as the second AI model 20 installed (or stored) on the electronic device 1000. The server 2000 may train the model corresponding to the first AI model 10 and the model corresponding to the second AI model 20 using the generated training image 2.

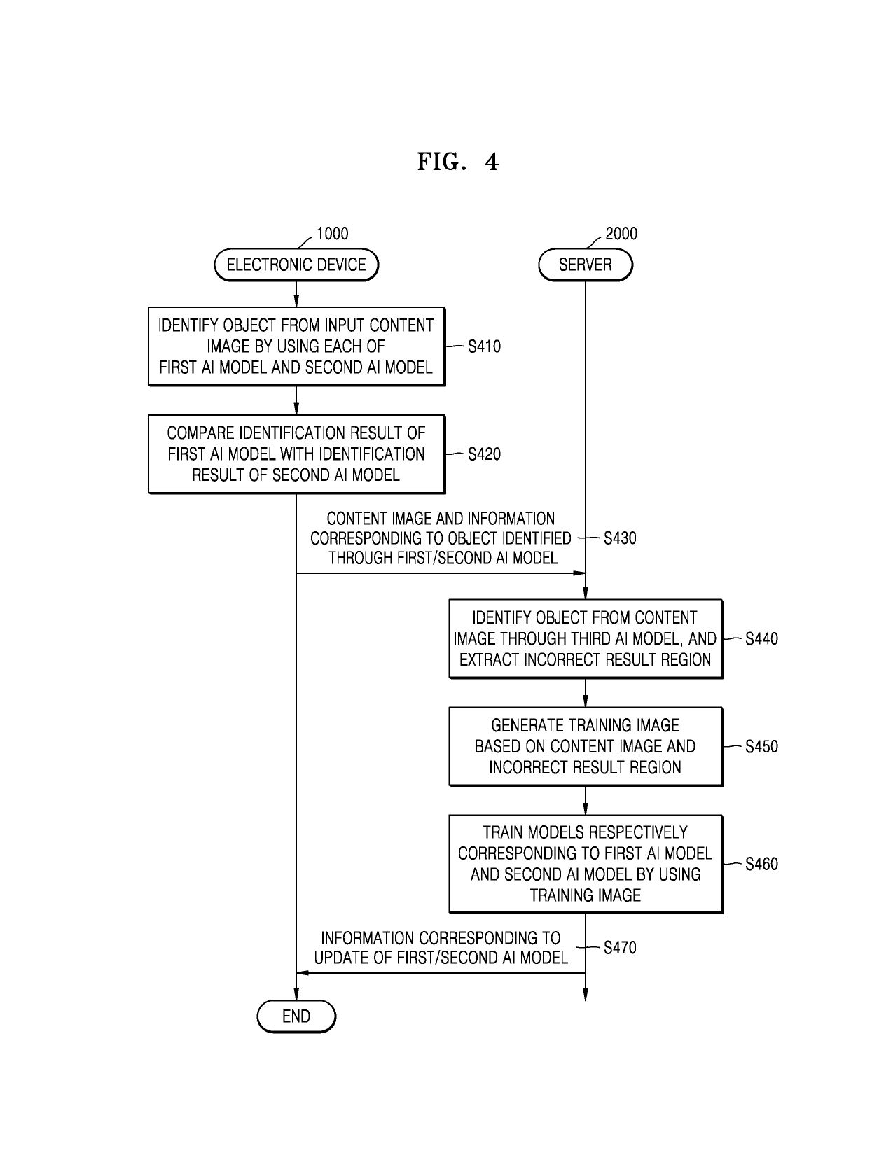

FIG. 4 is a signal flow diagram illustrating an example method of operating the system 100, according to various embodiments. Hereinafter, the method of operating the electronic device 1000, according to various embodiments, is described with reference to FIG. 4 in conjunction with FIG. 1. However, the descriptions with respect to FIGS. 2 and 3 apply equally to operations S410 to S470 illustrated in FIG. 4, so descriptions of the operations may not be repeated here.

In operation S410 of FIG. 4, the electronic device 1000 may identify one or more objects from the input content image 1 using each of the first AI model 10 and the second AI model 20. In operation S420 of FIG. 4, the electronic device 1000 may compare an object identification result of the first AI model 10 with an object identification result of the second AI model 20. When, in operation S420 of FIG. 4, the object identification result of the first AI model 10 is identified as being different from the object identification result of the second AI model 20, the electronic device 1000 performs operation S430 to transmit, to the server 2000, the content image 1, the information 11 corresponding to the one or more objects identified through the first AI model 10, and the information 21 corresponding to the one or more objects identified through the second AI model 20.

In operation S440 of FIG. 4, the server 2000 may identify one or more objects from the content image 1 through the third AI model 30, and extract the incorrect result region 31 from the content image 1. The incorrect result region 31 may be extracted as a region corresponding to an object identified differently from the content image 1 by the at least one electronic device 1000 and the server 2000.

In operation S450 of FIG. 4, the server 2000 may generate the training image 2 based on the content image 1 and the incorrect result region 31. In operation S460 of FIG. 4, the server 2000 may train models respectively corresponding to the first AI model 10 and the second AI model 20 using the training image 2.

In operation S470 of FIG. 4, the server 2000 may transmit, to the electronic device 1000, information corresponding to an update of at least one of the first AI model 10 or the second AI model 20.

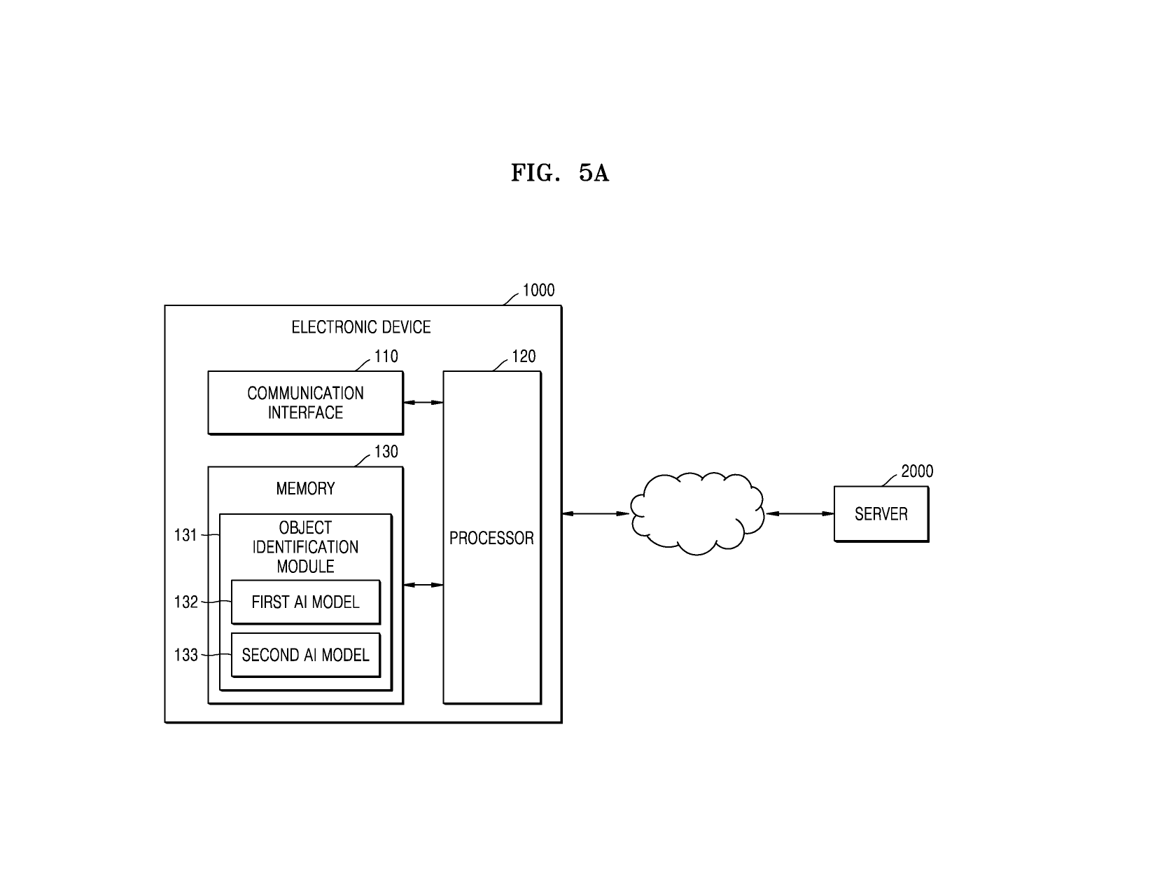

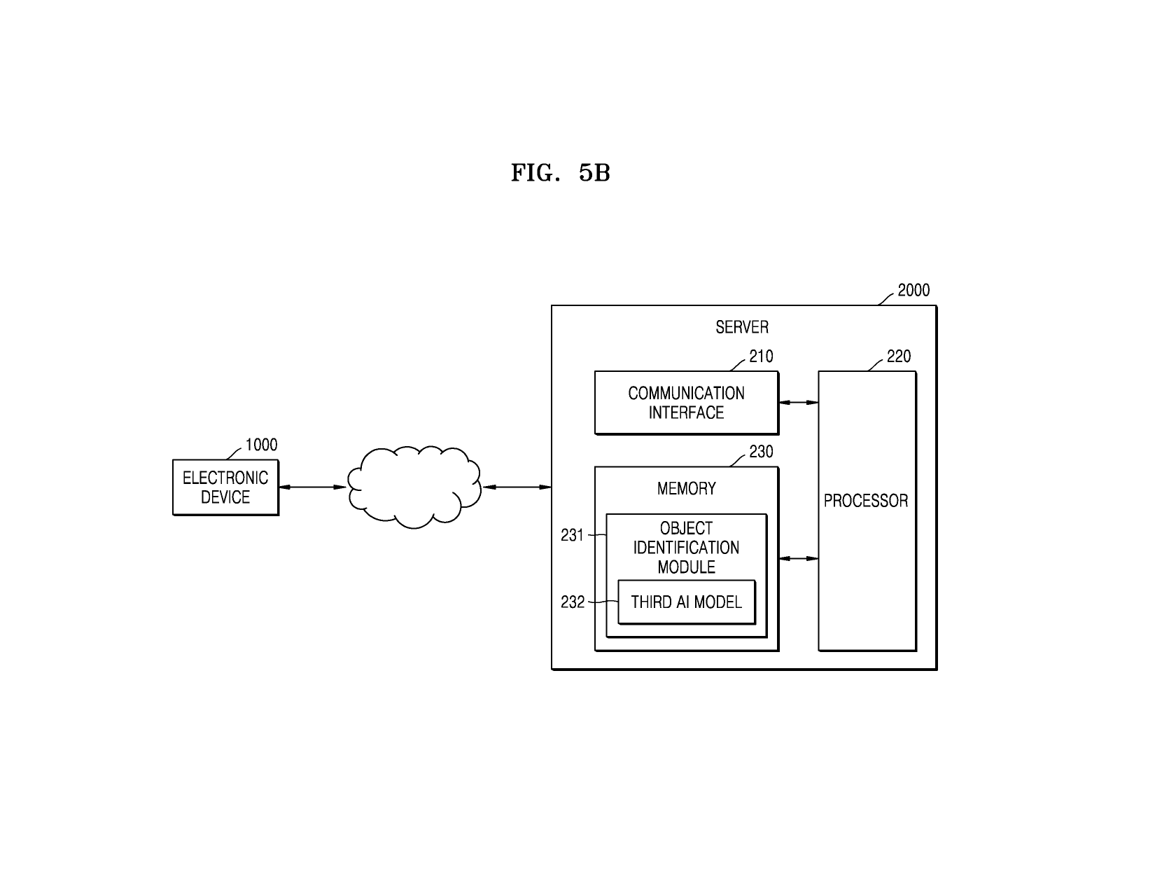

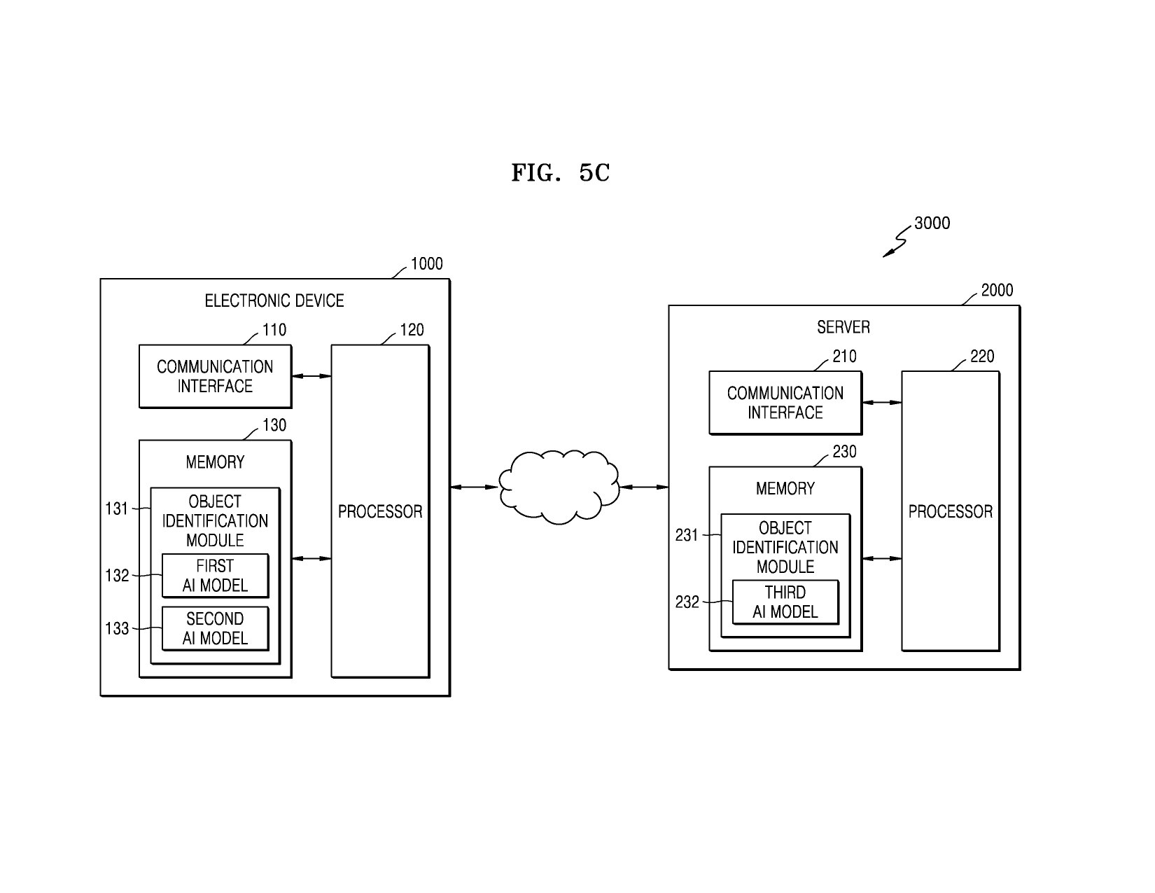

FIG. 5A is a block diagram illustrating an example configuration of the electronic device 1000 according to various embodiments.

Referring to FIG. 5A, according to an embodiment of the disclosure, the electronic device 1000 may include a communication interface (e.g., including communication circuitry) 110, a processor (e.g., including processing circuitry) 120, and a memory 130.

The communication interface 110 may include various communication circuitry and perform data communication with the server 2000 under control of the processor 120.

The communication interface 110 may include communication circuitry. The communication interface 110 may include communication circuitry capable of performing data communication between the electronic device 1000 and other devices using at least one of data communication methods including, for example, wired local area network (LAN), wireless LAN, Wi-Fi, Bluetooth, ZigBee, Wi-Fi Direct (WFD), Infrared Data Association (IrDA), Bluetooth Low Energy (BLE), near field communication (NFC), wireless broadband Internet (WiBro), World Interoperability for Microwave Access (WiMAX), Shared Wireless Access Protocol (SWAP), Wireless Gigabit Alliance (WiGig), and radio frequency (RF) communication.

The electronic device 1000 may transmit, to the server 2000, via the communication interface 110, information about a result of object identification from a content image performed within the electronic device 1000. The electronic device 1000 may receive, from the server 2000, via the communication interface 110, information corresponding to an update of at least one AI model installed on the electronic device 1000.

The memory 130 may store programs necessary for processing or control by the processor 120, and store data input to or output from the electronic device 1000. Furthermore, the memory 130 may store pieces of data necessary for operation of the electronic device 1000.

The memory 130 may include at least one type of storage medium, e.g., at least one of a flash memory-type memory, a hard disk-type memory, a multimedia card micro-type memory, a card-type memory (e.g., a Secure Digital (SD) or eXtreme Digital (xD) memory), random access memory (RAM), static RAM (SRAM), read-only memory (ROM), electrically erasable programmable ROM (EEPROM), PROM, magnetic memory, a magnetic disc, or an optical disc.

The processor 120 may include various processing circuitry and control operations of the electronic device 1000. For example, the processor 120 may execute one or more instructions stored in the memory 130 to perform functions of the electronic device 1000 described in the disclosure.

In an embodiment of the disclosure, the processor 120 may store one or more instructions in the memory 130 provided therein, and execute the one or more instructions stored in the memory 130 to control operations of the electronic device 1000 to be performed. In other words, the processor 120 may execute at least one instruction or program stored in an internal memory or the memory 130 provided within the processor 120 to perform operations.

The processor 120 may include various types of processing circuitry and/or a plurality of processors. For example, the term "processor" as used herein, including that in the claims, may include various types of processing circuitry including at least one processor. One or more of the at least one processor, individually and/or collectively in a distributed form, may be configured to perform various functions described herein. As used herein, "a processor," "at least one processor," and "one or more processors" may be configured to perform various functions. However, these terms cover, for example, without limitation, situations in which one processor performs some of recited functions and another processor (other processors) perform other functions, as well as situations in which a single processor may perform all of the recited functions. Furthermore, the at least one processor may include a combination of processors that perform various functions among the recited functions in a distributed manner. The at least one processor may execute program instructions to accomplish or perform various functions.

According to an embodiment of the disclosure, one or more instructions, when executed by the at least one processor 120 individually or collectively, may cause the electronic device 1000 to identify one or more objects through each of a first AI model 132 and a second AI model 133 based on an input content image. Each of the models may include various circuitry and/or executable program instructions. According to an embodiment of the disclosure, when the one or more objects identified through the first AI model 132 do not correspond to the one or more objects identified through the second AI model 133, the electronic device 1000 may transmit, to the server 2000, via the communication interface 110, the content image, information corresponding to the one or more objects identified through the first AI model 132, and information corresponding to the one or more objects identified through the second AI model 133. According to an embodiment of the disclosure, the electronic device 1000 may receive, from the server 2000, via the communication interface 110, information corresponding to an update of at least one of the first AI model 132 or the second AI model 133, which is obtained using a training image generated based on the content image, the information corresponding to the one or more objects identified through the first AI model 132, and the information corresponding to the one or more objects identified through the second AI model 133.

According to an embodiment of the disclosure, the electronic device 1000 may receive an input corresponding to object identification for each of a plurality of content images. According to an embodiment of the disclosure, when a resolution of each of the plurality of content images is less than a threshold value, the electronic device 1000 may execute each of the first AI model 132 and the second AI model 133 according to the reception of the input corresponding to the object identification, and when the resolution of each of the plurality of content images is greater than or equal to the threshold value, execute the first AI model 132 according to the reception of the input corresponding to the object identification and execute the second AI model 133 based on a defined frequency.

According to an embodiment of the disclosure, the electronic device 1000 may receive an input corresponding to object identification for each of a plurality of content images. According to an embodiment of the disclosure, the electronic device 1000 may execute the first AI model 132 and the second AI model 133 alternately according to the reception of the input corresponding to the object identification. According to an embodiment of the disclosure, the electronic device 1000 may execute both the first AI model 132 and the second AI model 133 when frequencies of execution of the first AI model 132 and the second AI model 133 correspond to a defined frequency.

According to an embodiment of the disclosure, when the one or more objects identified through the first AI model 132 do not correspond to the one or more objects identified through the second AI model 133, the electronic device 1000 may store the content image and the information corresponding to the one or more objects identified through the second AI model 133. According to an embodiment of the disclosure, the electronic device 1000 may train the first AI model 132 by inputting the information corresponding to the one or more objects identified through the second AI model 133 as a response to object identification in the content image.

According to an embodiment of the disclosure, information corresponding to an update of at least one of the first AI model 132 or the second AI model 133 may include at least one of a model that is obtained by updating the first AI model based on a training image and information corresponding to one or more objects identified from the training image through the server 2000 or a model that is obtained by updating the second AI model 133 based on the training image and the information corresponding to the one or more objects identified from the training image through the server 2000.

According to an embodiment of the disclosure, the training image may be based on the content image and an incorrect result region corresponding to an object identified differently by the electronic device 1000 and the server 2000.

According to an embodiment of the disclosure, the training image may correspond to an image obtained by specifying, based on a second feature prompt corresponding to the incorrect result region, a base image based on a first feature prompt corresponding to the remaining region of the content image other than the incorrect result region.

According to an embodiment of the disclosure, the content image may include a first content image having a first identification difficulty level based on the information corresponding to the one or more objects identified from the first content image through the first AI model being the same as information corresponding to one or more objects identified from the first content image through an AI model stored in the server 2000, and a second content image having a second identification difficulty level based on the information corresponding to the one or more objects identified from the second content image through the second AI model being the same as the information corresponding to the one or more objects identified from the second content image through the AI model stored in the server 2000. According to an embodiment of the disclosure, the training image may include a first training image corresponding to the first content image having the first identification difficulty level and a second training image corresponding to the second content image having the second identification difficulty level.

According to an embodiment of the disclosure, the electronic device 1000 may receive, from the server 2000, one of a first type AI model and a second type AI model that are trained from the first AI model 132 respectively based on a first type dataset and a second type dataset having different ratios between first training images and second training images. According to an embodiment of the disclosure, the electronic device 1000 may transmit a test result of one of the first type AI model and the second type AI model to the server 2000.

According to an embodiment of the disclosure, the electronic device 1000 may receive, from the server 2000, information corresponding to a final model determined from among the first AI model 132, the first type AI model, and the second type AI model based on a test result of the one of the first type AI model and the second type AI model.

According to an embodiment of the disclosure, the electronic device 1000 may update the first AI model 132 based on the received information corresponding to the final model.

FIG. 5B is a block diagram illustrating an example configuration of the server 2000, according to various embodiments.

Referring to FIG. 5B, according to an embodiment of the disclosure, the server 2000 may include a communication interface (e.g., including communication circuitry) 210, a processor (e.g., including processing circuitry) 220, and a memory 230.

The communication interface 210 may include various communication circuitry and perform data communication with at least one electronic device 1000 according to control by the processor 220.

The communication interface 210 may include communication circuitry. The communication interface 210 may include communication circuitry capable of performing data communication between the server 2000 and other devices using at least one of data communication methods including, for example, wired LAN, wireless LAN, Wi-Fi, Bluetooth, ZigBee, WFD, IrDA, BLE, NFC, WiBro, WiMAX, SWAP, WiGig, and RF communication.

The server 2000 may receive, from the electronic device 1000, via the communication interface 210, information about a result of object identification from a content image performed within the electronic device 1000. The server 2000 may transmit, to the electronic device 1000, via the communication interface 210, information corresponding to an update of at least one model installed on the electronic device 1000.

The memory 230 may store programs necessary for processing or control by the processor 220, and store data input to or output from the server 2000. Furthermore, the memory 230 may store pieces of data necessary for operation of the server 2000.

The memory 230 may include at least one type of storage medium, e.g., at least one of a flash memory-type memory, a hard disk-type memory, a multimedia card micro-type memory, a card-type memory (e.g., an SD card or an XD memory), RAM, SRAM, ROM, EEPROM, PROM, a magnetic memory, a magnetic disc, or an optical disc.

The processor 220 may include various processing circuitry and control operations of the server 2000. For example, the processor 220 may execute one or more instructions stored in the memory 230 to perform functions of the server 2000 described in the disclosure.

In an embodiment of the disclosure, the processor 220 may store one or more instructions in the memory 230 provided therein, and execute the one or more instructions stored in the memory 230 to control operations of the server 2000 to be performed. In other words, the processor 220 may execute at least one instruction or program stored in an internal memory or the memory 230 provided within the processor 220 to perform operations.

The processor 220 may include various types of processing circuitry and/or a plurality of processors. For example, the term "processor" as used herein, including that in the claims, may include various types of processing circuitry including at least one processor. One or more of the at least one processor, individually and/or collectively in a distributed form, may be configured to perform various functions described herein. As used herein, "a processor," "at least one processor," and "one or more processors" may be configured to perform various functions. However, these terms cover, without limitation, situations in which one processor performs some of recited functions and another processor (other processors) perform other functions, as well as situations in which a single processor may perform all of the recited functions. Furthermore, the at least one processor may include a combination of processors that perform various functions among the recited functions in a distributed manner. The at least one processor may execute program instructions to accomplish or perform various functions.

One or more instructions, when executed by the at least one processor 220 individually or collectively, may cause the server 2000 to receive, from the at least one electronic device 1000, a content image and information about one or more objects identified from the content image through one or more AI models stored in the at least one electronic device 1000. The server 2000 may identify one or more objects from the content image through an AI model stored in the server 2000 (each of which may include various circuitry and/or executable program instructions), and extract, from the content image, an incorrect result region corresponding to an object identified differently by the at least one electronic device 1000 and the server 2000. The server 2000 may generate a training image based on the content image and the incorrect result region and store the training image therein. The server 2000 may train one or more models corresponding to the one or more AI models stored in the electronic device 1000 using the stored training image.

According to an embodiment of the disclosure, one or more instructions, when executed by the at least one processor 220 individually or collectively, may cause the server 2000 to generate a base image based on features extracted from the remaining region of the content image other than the incorrect result region. The server 2000 may generate a training image by specifying the base image based on features extracted from the incorrect result region in the content image.

According to an embodiment of the disclosure, one or more instructions, when executed by the at least one processor 220 individually or collectively, may cause the server 2000 to obtain or generate a first feature prompt corresponding to the remaining region of the content image. The server 2000 may generate a base image based on the first feature prompt. The server 2000 may obtain or generate a second feature prompt corresponding to the incorrect result region in the content image. The server 2000 may generate a training image from the base image, based on the second feature prompt.

According to an embodiment of the disclosure, one or more instructions, when executed by the at least one processor 220 individually or collectively, may cause the server 2000 to identify one or more objects from the training image through the AI model stored in the server 2000, and store information corresponding to the one or more objects identified from the training image as a response to (or ground truth for) the object identification in the training image.

According to an embodiment of the disclosure, one or more instructions, when executed by the at least one processor 220 individually or collectively, may cause the server 2000 to determine an identification difficulty level of the content image as a first identification difficulty level when the information corresponding to the one or more objects identified from the content image through the first AI model 132 is the same as the information corresponding to the one or more objects identified from the content image through the AI model stored in the server 2000. When the information corresponding to the one or more objects identified from the content image through the second AI model is the same as the information corresponding to the one or more objects identified from the content image through the AI model stored in the server 2000, the server 2000 may determine an identification difficulty level of the content image as a second identification difficulty level. When a content image corresponding to a training image has the first identification difficulty level, the server 2000 may determine an identification difficulty level of the training image as the first identification difficulty level, and when a content image corresponding to a training image has the second identification difficulty level, the server 2000 may determine an identification difficulty level of the training image as the second identification difficulty level.

According to an embodiment of the disclosure, one or more instructions, when executed by the at least one processor 220 individually or collectively, may cause the server 2000 to train models corresponding to the first AI model respectively based on a first type dataset and a second type dataset that have different ratios between training images with the first identification difficulty level and training images with the second identification difficulty level.

According to an embodiment of the disclosure, one or more instructions, when executed by the at least one processor 220 individually or collectively, may cause the server 2000 to store a first type AI model trained based on the first type dataset and a second type AI model trained based on the second type dataset. The server 2000 may distribute the first type AI model to one group of the at least one electronic device 1000, and the second type AI model to another group of the at least one electronic device 1000. The server 2000 may receive information about a test result of the first type AI model from the one group of the at least one electronic device 1000. The server 2000 may receive information about a test result of the second type AI model from the other group of the at least one electronic device 1000. The server 2000 may receive information about a test result of the first AI model from the remaining electronic devices, excluding the one group and the other group of the at least one electronic device 1000. The server 2000 may determine a final model from among the first AI model, the first type AI model, and the second type AI model, based on information about the test result of the first type AI model, information about the test result of the second type AI model, and information about the test result of the first AI model. When the determined final model is the first type AI model or the second type AI model, the server 2000 may distribute the determined first type AI model or second type AI model to all of the at least one electronic device 1000.

According to an embodiment of the disclosure, one or more instructions, when executed by the at least one processor 220 individually or collectively, may cause the server 2000 to train models corresponding to the second AI model 133 respectively based on a third type dataset and a fourth type dataset that have different ratios between training images with the first identification difficulty level and training images with the second identification difficulty level.

According to an embodiment of the disclosure, the content image received from the at least one electronic device 1000 may correspond to an image in which the one or more objects identified through the first AI model 132 are different from the one or more objects identified through the second AI model 133.

In an embodiment of the disclosure, the memory 230 may include an object identification module 231. A 'module' included in the memory 230 may refer to a unit for processing functions or operations performed by the processor 220, and may be implemented as software such as instructions, algorithms, data structures, or program code.

The object identification module 231 may include appropriate logic, circuitry, interfaces, and/or code operable to identify (or detect) one or more objects in an input image using one or more AI models. In an embodiment of the disclosure, the object identification module 231 stored in the server 2000 may include a third AI model 232. For example, the third AI model 232 may correspond to a large model.

Furthermore, although not shown, the server 2000 may perform model training for each of the first AI model 132 and the second AI model 133 installed on the electronic device 1000, and the memory 230 may include a model corresponding to the first AI model 132 and a model corresponding to the second AI model 133.

In addition, although not shown, the memory 230 may further include a feature prompt extraction module. The feature prompt extraction module may include appropriate logic, circuitry, interfaces, and/or code operable to generate an image-generating prompt from an input image based on features extracted from input image.

Moreover, although not shown, the memory 230 may further include an image generation module. The image generation module may include appropriate logic, circuitry, interfaces, and/or code operable to generate a new image based on a feature prompt using one or more neural networks.

FIG. 5C is a block diagram illustrating an example configuration of the system 3000 according to various embodiments.

Referring to FIG. 5C, according to an embodiment of the disclosure, the system 3000 may include the electronic device 1000 and the server 2000 connected to a communication network. According to an embodiment of the disclosure, the electronic device 1000 may include the communication interface 110, the processor 120, and the memory 130. According to an embodiment of the disclosure, the server 2000 may include the communication interface 210, the processor 220, and the memory 230. However, the descriptions with respect to FIGS. 5A and 5B apply equally to components illustrated in FIG. 5C, so descriptions of the components may not be repeated here.

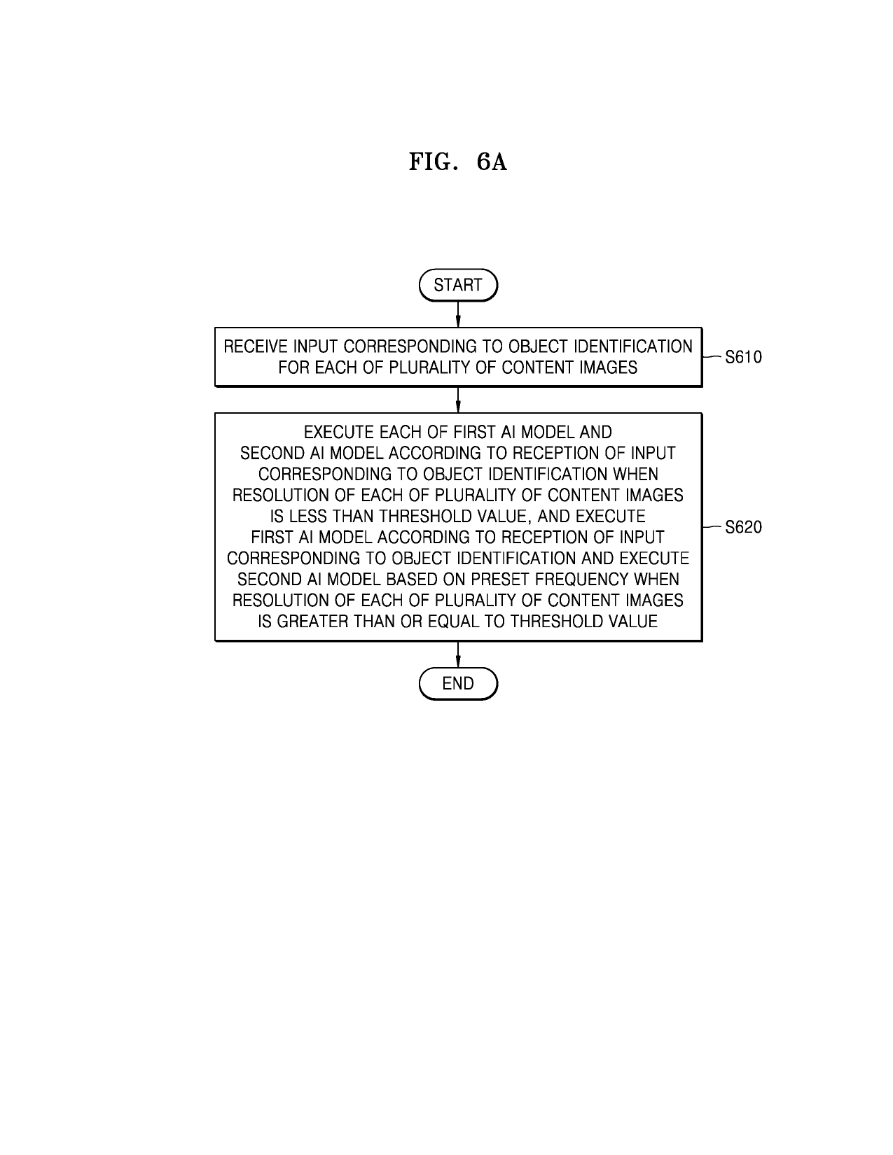

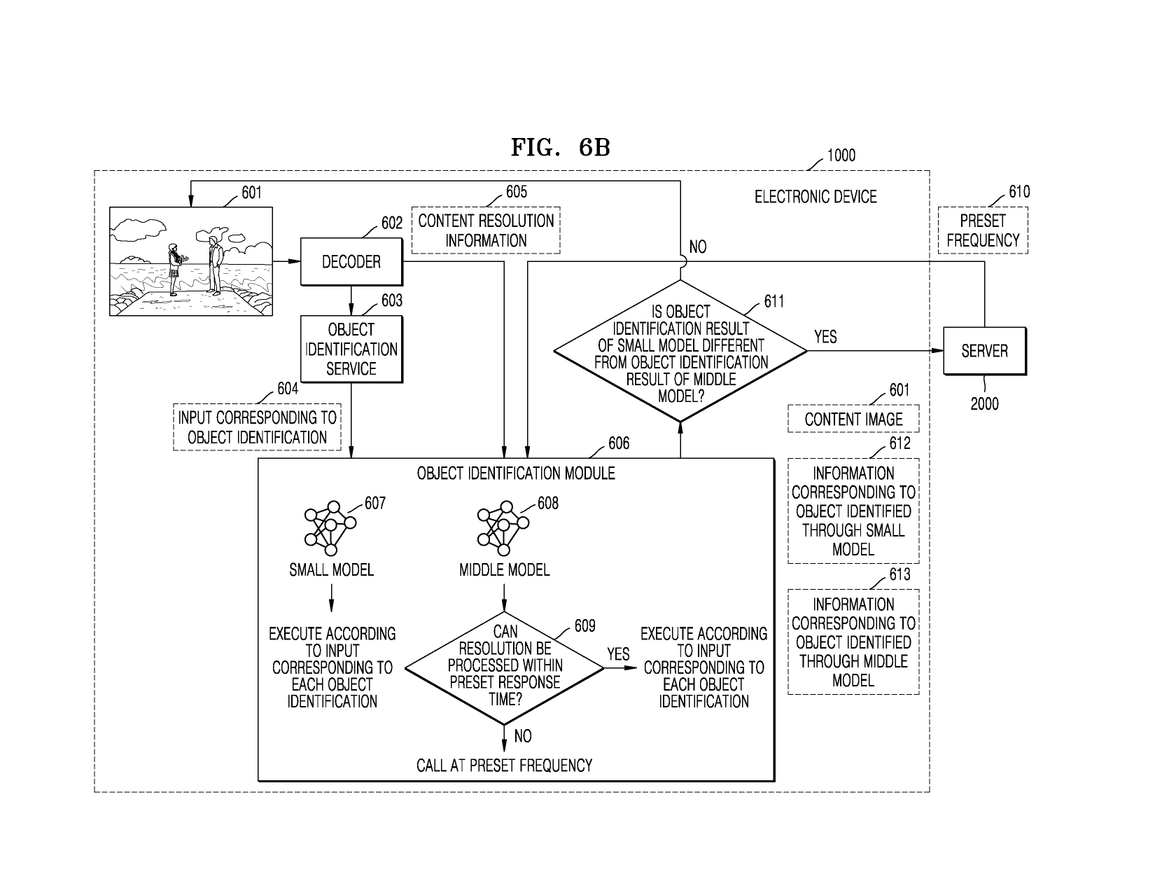

FIG. 6A is a flowchart illustrating an example operation, performed by the electronic device 1000, of transmitting, to the server 2000, content images and information about objects identified through models, according to various embodiments. FIG. 6B is a diagram illustrating an example operation, performed by the electronic device 1000, of transmitting, to the server 2000, a content image and information about one or more objects identified through models, according to various embodiments.

In operation S610 of FIG. 6A, the electronic device 1000 may receive an input corresponding to object identification for each of a plurality of content images. For example, the electronic device 1000 may provide a user interface capable of receiving a request for object identification for each of the plurality of content images, and receive a user input requesting object identification via the user interface.

Referring to FIGS. 6A and 6B together, according to an embodiment of the disclosure, the electronic device 1000 may restore, via a decoder 602, data of a content image 601 received in a compressed format to its original image format before compression. The decoder 602 may interpret encoded input data and decode image data (or video data)contained in the input data using a decoding method suitable for the input data.

In an embodiment of the disclosure, the electronic device 1000 may provide an object identification service 603. For example, the electronic device 1000 may provide a sports broadcast video, and at the same time, identify a player appearing in the sports broadcast video and provide a user interface containing information about the player by overlaying the user interface on the sports broadcast video. For example, the electronic device 1000 may provide a multimedia content video, and at the same time, identify a celebrity, such as an actor, appearing in the multimedia content video and provide a user interface containing information about the celebrity by overlaying the user interface on the multimedia content video. For example, the electronic device 1000 may obtain search results for information about a person appearing in a video through a search server or a cloud server.

In an embodiment of the disclosure, the electronic device 1000 may receive an input 604 corresponding to object identification based on the object identification service 603 being activated. Although FIG. 6B typically illustrates the electronic device 1000 receiving one content image 601, in practice, the electronic device 1000 may receive consecutive frames while providing a content video. Therefore, the electronic device 1000 may receive the input 604 corresponding to object identification for each of a plurality of content images 601 corresponding to the consecutive frames.

In an embodiment of the disclosure, the electronic device 1000 may obtain resolution information of each of the plurality of content images.

In an embodiment of the disclosure, the electronic device 1000 may obtain resolution information 605 of the content image 601 (also hereinafter, content resolution information 605) from the decoder 602. The electronic device 1000 may determine a frequency (or execution frequency) 610 of a middle model based on the resolution information 605 of the content image 601, taking into account that a response time of the middle model varies depending on the resolution information 605 of the content image 601.

In operation S620 of FIG. 6A, when a resolution of each of the plurality of content images is less than a threshold value, the electronic device 1000 may execute each of a first AI model and a second AI model according to the reception of the input corresponding to the object identification. In operation S620 of FIG. 6A, when the resolution of each of the plurality of content images is greater than or equal to the threshold value, the electronic device 1000 may execute the first AI model according to the reception of the input corresponding to the object identification, and execute the second AI model based on a defined frequency.

Referring to FIGS. 6A and 6B together, in an embodiment of the disclosure, an object identification module 606 in the electronic device 1000 may include the first AI model and the second AI model, and FIG. 6B illustrates an example in which the first AI model is a small model 607 and the second AI model is a middle model 608.

In an embodiment of the disclosure, the electronic device 1000 may perform object identification using the small model 607 according to receiving an input corresponding to each object identification. The electronic device 1000 may perform object identification using the small model 607 each time an input corresponding to object identification is received. For example, the small model 607 may be a model actually used when object identification needs to be performed in providing the object identification service 603 of the electronic device 1000.

In an embodiment of the disclosure, based on the content resolution information 605 obtained from the decoder 602, the electronic device 1000 may identify (609) whether a resolution is within a range of resolutions that can be processed within a preset response time.

For example, it is assumed that a response time constraint of the object identification module 606 is 150 ms. When a content resolution is a first resolution, (e.g., a 640 x 320 resolution), the time required for object identification by the small model 607 may be 20 ms, and the time required for object identification by the middle model 608 may be 100 ms. In this case, the electronic device 1000 may identify that the total time required for object identifications by the small model 607 and the middle model 608 does not exceed the response time constraint of the object identification module 606. Accordingly, based on the content resolution being within the range of resolutions that can be processed within the preset response time, the electronic device 1000 may execute the middle model 608 in the same manner as when executing the small model 607, according to receiving an input corresponding to each object identification. Based on the content resolution being within the range that can be processed within the preset response time, the electronic device 1000 may execute the middle model 608 in the same manner as when executing the small model 607 each time an input corresponding to each object identification is received.

For example, when the content resolution is a second resolution (e.g., a 1280x720 resolution) higher than the first resolution, the time required for object identification by the small model 607 may be 80 ms, and the time required for object identification by the middle model 608 may be 400 ms. In this case, the electronic device 1000 may identify that the total time required for object identifications by the small model 607 and the middle model 608 exceeds the response time constraint of the object identification module 606. Accordingly, based on the content resolution exceeding the range that can be processed within the preset response time, the electronic device 1000 may call the middle model 608 at a defined(e.g., specified, predefined, (pre)determined, or preset) frequency.

In an embodiment of the disclosure, the electronic device 1000 may receive the defined(e.g., specified, predefined, (pre)determined, or preset) frequency 610 from the server 2000. For example, the execution frequency 610 may be provided in time units, and the electronic device 1000 may execute the middle model 608 at intervals of a defined (e.g., specified, predefined, (pre)determined, or preset) time period. For example, based on the amount of collected datasets, the server 2000 may set the middle model 608 to be executed at intervals of a first time period (e.g., 1 minute) to perform object identification for one frame per minute when the amount of collected datasets is small (or less than a threshold value). For example, based on the amount of collected datasets, the server 2000 may set the middle model 608 to be executed at intervals of a second time period (e.g., 5 minutes), which is longer than the first time period (e.g., 1 minute), to perform object identification for one frame every 5 minutes when the amount of collected datasets is large (or greater than or equal to the threshold value).

When the small model 607 and the middle model 608 are both executed in the object identification module 606, the electronic device 1000 may compare (611) an object identification result of the small model 607 for the content image 601 with an object identification result of the middle model 608 for the content image 601. When the object identification result of the small model 607 for the content image 601 is identified as being different from the object identification result of the middle model 608 for the content image 601, the electronic device 1000 may transmit, to the server 2000, the content image 601, information 612 corresponding to an object identified through the small model 607, and information 613 corresponding to an object identified through the middle model 608. When the information 612 corresponding to the object identified from the content image 601 through the small model 607 does not correspond to the information 613 corresponding to the object identified therefrom through the middle model 608, the electronic device 1000 may transmit, to the server 2000, the content image 601, the information 612 corresponding to the object identified through the small model 607, and the information 613 corresponding to the object identified through the middle model 608. For example, the information 612 corresponding to the object identified through the small model 607 and the information 613 corresponding to the object identified through the middle model 608 may each include object class information and object position information.

When the object identification result of the small model 607 for the content image 601 is identified as being identical to the object identification result of the middle model 608 for the specific content image 601, the electronic device 1000 may determine that object identification in the content image 601 has been performed correctly in both the small model 607 and the middle model 608, and may not transmit any information to the server 2000. When the information 612 corresponding to the object identified from the content image 601 through the small model 607 corresponds to the information 613 corresponding to the object identified through the middle model 608, the electronic device 1000 may not transmit any information to the server 2000.

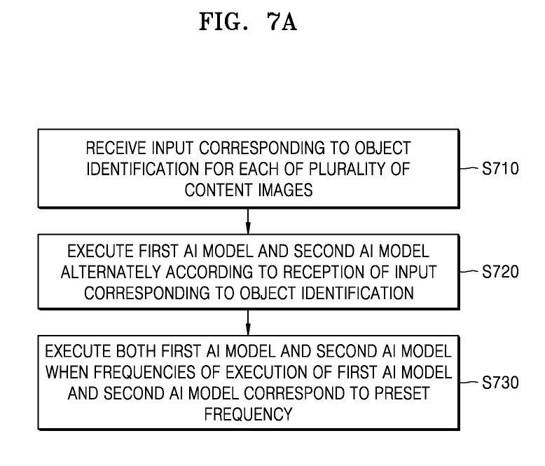

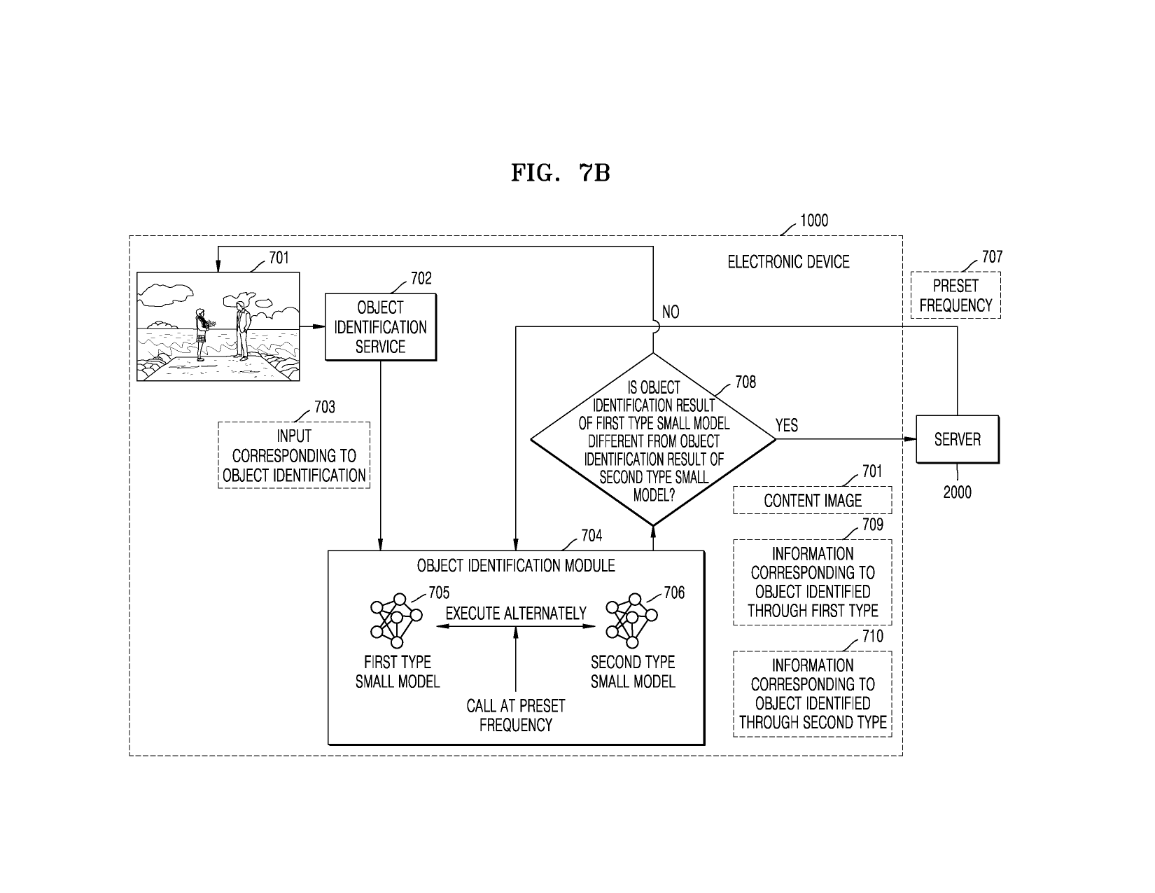

FIG. 7A is a flowchart illustrating an example operation, performed by the electronic device 1000, of transmitting, to the server 2000, a content image and information about objects recognized through models, according to various embodiments. FIG. 7B is a diagram illustrating an example operation, performed by the electronic device 1000, of transmitting, to the server 2000, a content image and information about objects recognized through models, according to various embodiments.

In operation S710 of FIG. 7A, the electronic device 1000 may receive an input corresponding to object identification for each of a plurality of content images.

Referring to FIGS. 7A and 7B together, the electronic device 1000 may receive an input 703 corresponding to object identification, based on an object identification service 702 being activated. Although FIG. 7B illustrates the electronic device 1000 receiving one content image 701, in practice, the electronic device 1000 may receive consecutive frames while providing a content video. Therefore, the electronic device 1000 may receive the input 703 corresponding to object identification for each of the plurality of content images 701 corresponding to the consecutive frames.

In operation S720 of FIG. 7A, the electronic device 1000 may alternately execute a first AI model and a second AI model according to the reception of the input corresponding to the object identification. In operation S730 of FIG. 7A, the electronic device 1000 may execute both the first AI model and the second AI model when frequencies of execution of the first AI model and the second AI model correspond to a defined frequency.

Referring to FIGS. 7A and 7B together, in an embodiment of the disclosure, an object identification module 704 in the electronic device 1000 may include the first AI model and the second AI model, and FIG. 7B illustrates an example in which the first AI model and the second AI model are both small models, but are of different types. The first AI model may be referred to as a first type of small model 705, and the second AI model may be referred to as a second type of small model 706. For example, the first type of small model 705 may be an EfficientDet object detection model, and the second type of small model 706 may be a Damo-YOLO object detection model.

In an embodiment of the disclosure, the electronic device 1000 may execute the first type of small model 705 and the second type of small model 706 alternately according to receiving an input corresponding to each object identification. In an embodiment of the disclosure, the electronic device 1000 may execute the first type of small model 705 and the second type of small model 706 alternately each time an input corresponding to each object identification is received. For example, both the first type of small model 705 and the second type of small model 706 may be models actually used when object identification needs to be performed in providing the object identification service 702 of the electronic device 1000.

In an embodiment of the disclosure, the electronic device 1000 may receive a defined (e.g., specified, predefined, (pre)determined, or preset) frequency 707 from the server 2000. For example, the defined (e.g., specified, predefined, (pre)determined, or preset) frequency 707 may be provided in time units, and the electronic device 1000 may execute both the first type of small model 705 and the second type of small model 706 at intervals of a defined (e.g., specified, predefined, (pre)determined, or preset) time period. For example, based on the amount of collected datasets, the server 2000 may set both the first type of small model 705 and the second type of small model 706 to be executed at intervals of a first time period (e.g., 1 minute) when the amount of collected datasets is small (or less than a threshold value). For example, based on the amount of collected datasets, the server 2000 may set both the first type of small model 705 and the second type of small model 706 to be executed at intervals of a second time period (e.g., 5 minutes), which is longer than the first time period, when the amount of collected datasets is large (or greater than or equal to the threshold value).

When the first type of small model 705 and the second type of small model 706 are both executed in the object identification module 704, the electronic device 1000 may compare (708) an object identification result of the first type of small model 705 for the content image 701 with an object identification result of the second type of small model 706 for the content image 701. When the object identification result of the first type of small model 705 for the specific content image 701 is identified as being different from the object identification result of the second type of small model 706 for the content image 701, the electronic device may determine that the content image 701 is an image for which object identification is difficult. Therefore, the electronic device 1000 may transmit, to the server 2000, the content image 701, information 709 corresponding to an object identified through the first type of small model 705, and information 710 corresponding to an object identified through the second type of small model 706. When the information 709 corresponding to the object identified from the content image 701 through the first type of small model 705 does not correspond to the information 710 corresponding to the object identified therefrom through the second type of small model 706, the electronic device 1000 may transmit, to the server 2000, the specific content image 701, the information 709 corresponding to the object identified through the first type of small model 705, and the information 710 corresponding to the object identified through the second type of small model 706. For example, the information 709 corresponding to the object identified through the first type of small model 705 and the information 710 corresponding to the object identified through the second type of small model 706 may each include object class information and object position information.

When the object identification result of the first type of small model 705 for the content image 701 is identified as being identical to the object identification result of the second type of small model 706 for the specific content image 701, the electronic device 1000 may determine that object identification in the specific content image 701 has been performed correctly in both the first type of small model 705 and the second type of small model 706, and may not transmit information about the content image 701 to the server 2000 that performs model training. When the information 709 corresponding to the object identified from the content image 701 through the first type of small model 705 corresponds to the information 710 corresponding to the object identified therefrom through the second type of small model 706, the electronic device 1000 may not transmit the information about the specific content image 701 to the server 2000 that performs model training.

Hereinafter, an operation, performed by the server 2000, of generating a training image based on a content image received from the electronic device 1000 is described in greater detail with reference to FIGS. 8A to 8C.

FIG. 8A is a flowchart illustrating an example operation, performed by the server 2000, of generating a training image, according to various embodiments. FIG. 8B is a flowchart illustrating an example operation, performed by the server 2000, of generating a training image, according to various embodiments. FIG. 8C is a diagram illustrating an example operation, performed by the server 2000, of generating a training image, according to various embodiments.

Operation S810 illustrated in FIG. 8A is a detailed operation of operation S330 of FIG. 3. Operation S810 illustrated in FIG. 8A may be performed after operation S320 illustrated in FIG. 3 is performed. Operation S340 illustrated in FIG. 3 may be performed after operation S820 illustrated in FIG. 8A is performed.

In operation S810 of FIG. 8A, the server 2000 may generate a base image based on features extracted from the remaining region of the content image other than the incorrect result region.

In operation S820 of FIG. 8A, the server 2000 may generate a training image by specifying the base image based on features extracted from the incorrect result region in the content image.

In an embodiment of the disclosure, the server 2000 may extract, from the content image, the incorrect result region corresponding to the object that is different from the object identified by the AI models installed on the electronic device 1000 among the one or more objects identified by the AI model installed on the server 2000. In other words, the incorrect result region may represent a region including an object that is difficult to identify using the one or more AI models installed on the electronic device 1000.

In an embodiment of the disclosure, the training image may be based on the content image and the incorrect result region corresponding to the object identified differently by the electronic device 1000 and the server 2000. In an embodiment of the disclosure, the training image may correspond to an image obtained by specifying, based on the features extracted from the incorrect result region, the base image extracted from the features extracted from the remaining region of the content image other than the incorrect result region.

According to an embodiment of the disclosure, when generating a training image from the content image received from the electronic device 1000, the server 2000 may generate the training image in which the incorrect result region is expressed in more detail than when the entire content image is expressed at once, by depicting the incorrect result region separately from the remaining region of the content image other than the incorrect result region. The server 2000 may train the AI models installed on the electronic device 1000 using the training image in which the incorrect result region is represented in detail, thereby improving the identification performance for incorrect result regions that were not previously identified.

Operations S811 and S812 in FIG. 8B are detailed operations of operation S810 in FIG. 8A. Operations S821 and S822 in FIG. 8B are detailed operations of operation S820 in FIG. 8A. Operation S811 illustrated in FIG. 8A may be performed after operation S320 illustrated in FIG. 3 is performed. Operation S340 illustrated in FIG. 3 may be performed after operation S822 illustrated in FIG. 8A is performed.

In operation S811 of FIG. 8B, the server 2000 may generate a first feature prompt corresponding to the remaining region of the content image. In operation S812 of FIG. 8B, the server 2000 may generate a base image based on the first feature prompt. In the disclosure, the first feature prompt may also be referred to as a base image feature prompt.

In the disclosure, a 'prompt' may be used as input information necessary for a generative model to perform a task. The prompt may include natural language text. The natural language text may include various pieces of information, such as tasks that indicate tasks to be performed by the generative model, and components available when the generative model performs the tasks, such as context, intent, constraints, and examples. In an embodiment of the disclosure, the electronic device 1000 may process natural language text using a natural language processing (NLP) model. In the disclosure, the prompt may be replaced with an input, a command, a directive, an input phrase, a starting sentence, a task query, a trigger sentence, etc.

In an embodiment of the disclosure, the prompt may include a multimedia prompt that integrates various types of media elements, including text, images, audio, video, music, and animation. The multimedia prompt may be a combination of different types of media elements in the same situation.

In an embodiment of the disclosure, the first feature prompt (or the base image feature prompt) may be generated based on features extracted from (or depicted in) an input image, and the server 2000 may generate a base image based on the first feature prompt (or the base image feature prompt).

Referring to FIGS. 8B and 8C together, according to an embodiment of the disclosure, the server 2000 may generate a base image feature prompt 804 through a prompt generation module 810. The server 2000 may generate, via the prompt generation module 810, the base image feature prompt 804 from the content image 801 with an incorrect result region 802 masked. In generating the base image feature prompt 804, the server 2000 may extract features related to the remaining region 803 other than the incorrect result region 802 using the content image 801 with the incorrect result region 802 masked. For example, the prompt generation module 810 may extract, from an input image, general features of the image, and generate the base image feature prompt 804 that describes the general features of the image. For example, the prompt generation module 810 may generate, from the input image, the base image feature prompt 804 that describes the composition, background, foreground, person, action, lighting, color tone, texture, mood, etc. within the image.

The server 2000 may generate, via the prompt generation module 810, from the input content image 801 with the incorrect result region 802 masked, the base image feature prompt 804 as "A stone breakwater stretches out toward the sea against the backdrop of an open beach. Small pebbles and water remain on the ground, indicating that it has recently rained or that seawater has splashed. Gentle waves are breaking on the sea, and clouds are hanging in the overcast sky. A seagull flying in the sky is seen in the distance, and the overall atmosphere is calm and quiet. The horizon where the sea and sky meet is clearly visible, and the blue of the sea and the gray of the sky naturally harmonize. In the image, a man is standing on the right side, looking toward the left. The man is wearing an ivory-colored knit sweater, gray slacks, and white sneakers. He has his hands in his pockets."

In the base image feature prompt 804 presented as an example above, first and second sentences describe features related to the background and foreground of the input image, and third and fourth sentences describe features related to the lighting, color tone, and mood of the input image. In the base image feature prompt 804 provided as an example, a fifth sentence describes features related to the composition, and sixth to eighth sentences describe features related to the person. The person depicted in the base image feature prompt 804 is an object that does not correspond to the incorrect result region 802, and may correspond to an object that has been appropriately identified by one or more AI models installed on the electronic device 1000.

According to an embodiment of the disclosure, the electronic device 1000 may generate the base image feature prompt 804 written using a script writing tool according to a defined(e.g., specified, predefined, (pre)determined, or preset) template based on the input image. Moreover, according to an embodiment of the disclosure, the electronic device 1000 may also generate the base image feature prompt 804 via an AI model (e.g., a generative model).

In operation S821 of FIG. 8B, the server 2000 may generate a second feature prompt corresponding to the incorrect result region 802 of the content image 801. In operation S822 of FIG. 8B, the server 2000 may generate a training image 807 from a base image 805, based on the second feature prompt. In the disclosure, the second feature prompt may also be referred to as an incorrect result region image feature prompt 806.

In an embodiment of the disclosure, the training image 807 may correspond to an image obtained by specifying, based on the second feature prompt corresponding to the incorrect result region 802, the base image 805 based on the first feature prompt corresponding to the remaining region of the content image 801 other than the incorrect result region 802.

In an embodiment of the disclosure, the second feature prompt (or the incorrect result region image feature prompt 806) may be generated based on features extracted from (or depicted in)the input image, and the server 2000 may generate an image related to the incorrect result region 802 based on the second feature prompt (or the incorrect result region image feature prompt 806).

Referring to FIGS. 8B and 8C together, according to an embodiment of the disclosure, the server 2000 may generate the incorrect result region image feature prompt 806 through the prompt generation module 810. The server 2000 may generate, via the prompt generation module 810, the incorrect result region image feature prompt 806 from an image extracted as the incorrect result region 802. The server 2000 may describe the incorrect result region 802 in detail by generating the incorrect result region image feature prompt 806 from the image extracted as the incorrect result region 802. For example, unlike generating the base image feature prompt 804, the prompt generation module 810 may extract (or describe) features related to an object included in the incorrect result region 802 in detail, thereby generating the incorrect result region image feature prompt 806 that describes the object in detail. For example, the prompt generation module 810 may generate the incorrect result region image feature prompt 806 from the input image, which describes detailed features such as the type, size, color, composition, pattern, and posture of an object in the image.

The server 2000 may generate, via the prompt generation module 810, from the image of the incorrect result region 802, the incorrect result region image feature prompt 806 stating "Type: Teenage girl or young woman", "Size: The height of the person in the image is about one-fourth of the image, and the length of her legs and upper body are in natural proportion", "Color: She is wearing a gray hoodie and a dark red scarf, with her legs exposed by a short checkered skirt. Shoes are comfortable shoes, such as dark-colored sneakers or loafers", "Composition: She is standing on the left side of the screen, slightly turned to the right to face the man, and is holding a small bouquet of green flowers in her right hand and offering it to the man. Her gaze is naturally directed toward the bouquet", "Pattern: The hoodie and scarf have no patterns, while the skirt has a dark-colored, repeated plaid (checkered) pattern. Generally, the outfit is casual but gives the impression of a school uniform ", "Posture: She is extending her right hand forward to offer the flowers, and standing with her legs slightly apart in a stable posture. Her waist and upper body are naturally straightened, and she has a somewhat calm demeanor", "Other descriptions: Her short hair falls naturally beside her ears, and her facial expression gives a peaceful and thoughtful impression. The scarf stands out as a contrasting element in the landscape, and its red color harmonizes with the surrounding calming tones." In the incorrect result region image feature prompt 806 presented as the above example, features such as the type, size, color, composition, pattern, and posture of the object included in the incorrect result region 802 are described in detail.

According to an embodiment of the disclosure, by generating the incorrect result region image feature prompt 806 separately from the base image feature prompt 804, the incorrect result region 802 may be described in more detail than when generating a feature prompt for the entire content image 801. Thus, the server 2000 may train one or more AI models installed on the electronic device 1000 using the training image 807 in which the incorrect result region is depicted in detail, thereby improving the identification performance for the incorrect result region 802 that was not previously identified.

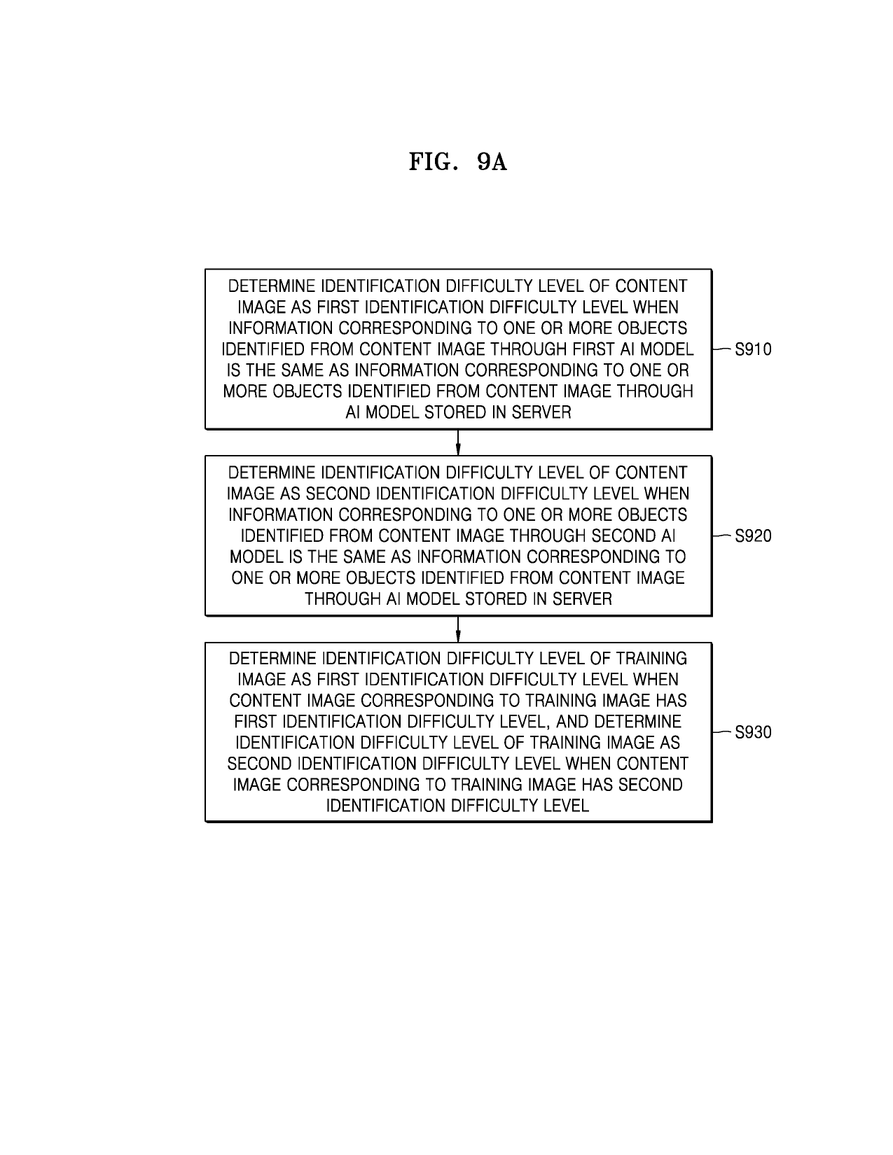

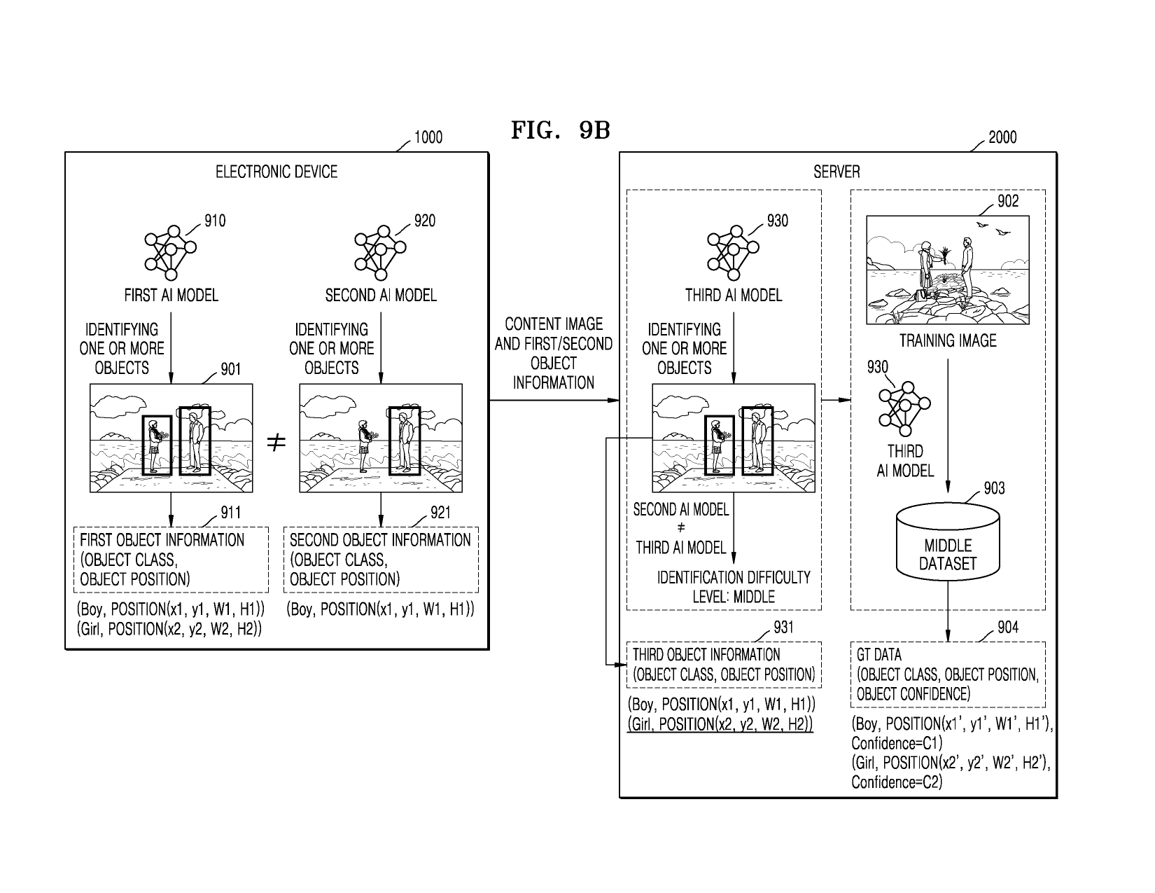

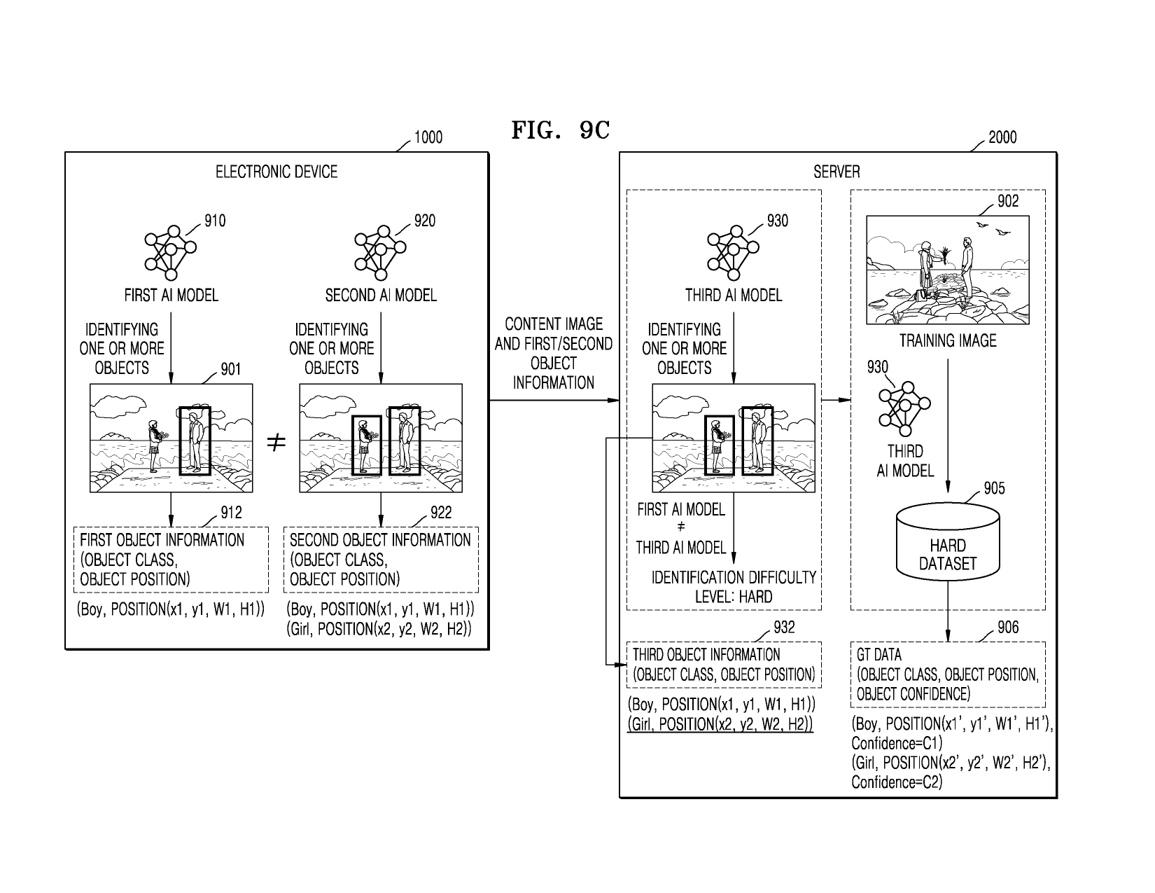

Hereinafter, an operation, performed by the server 2000, of determining ground truth data (or GT data) and an identification difficulty level of the generated training image is described in greater detail with reference to FIGS. 9A to 9C.

FIG. 9A is a flowchart illustrating an example operation, performed by the server 2000, of determining an identification difficulty level of each of a content image and a training image, according to various embodiments. FIG. 9B is a diagram illustrating an example operation, performed by the server 2000, of determining an identification difficulty level of each of a content image and a training image and storing the training image, according to various embodiments. FIG. 9C is a diagram illustrating an example operation, performed by the server 2000, of determining an identification difficulty level of each of a content image and a training image and storing the training image, according to various embodiments.

Referring to FIGS. 9A to 9C, according to an embodiment of the disclosure, the server 2000 may determine an identification difficulty level of each of a content image and a training image. The server 2000 may determine an identification difficulty level of a training image, based on an identification difficulty level of a content image, and training images may be stored according to an identification difficulty level thereof.

In operation S910 of FIG. 9A, when information corresponding to one or more objects identified from a content image through a first AI model is the same as information corresponding to one or more objects identified from the content image through an AI model stored in the server 2000, the server 2000 may determine an identification difficulty level of the content image as a first identification difficulty level.

Referring to FIGS. 9A and 9B together, a first AI model 910 and a second AI model 920 may be installed on the electronic device 1000, and an example in which the first AI model 910 is a small model and the second AI model 920 is a middle model is illustrated.

The first AI model 910 installed on the electronic device 1000 may identify one or more objects from an input content image 901 and output first object information 911 including an object class and an object position corresponding to the identified one or more objects (or information corresponding to the one or more objects identified through the first AI model 910). The first object information 911 includes information about the one or more objects, and may be displayed as "(object class, object position)".

For example, the first AI model 910 may identify a man (or Boy) and a woman (or Girl) from the input content image 901, and the first object information 911 related to the Boy may be displayed as "(Boy, Boy's position)", and the first object information 911 related to the Girl may be displayed as "(Girl, Girl's position)". For example, an object position may be represented by four values "(x, y, W, H)" that define the bounding box. x represents an x-coordinate of an upper-left corner of the bounding box, y represents a y-coordinate of the upper-left corner of the bounding box, W represents a width of the bounding box, and H represents a height of the bounding box. The Boy's position may be represented as "(x1, y1, W1, H1)", and the Girl's position may be represented as "(x2, y2, W2, H2)".

The second AI model 920 installed on the electronic device 1000 may identify one or more objects from the input content image 901 and output second object information 921 including an object class and an object position corresponding to the identified one or more objects (or information corresponding to the one or more objects identified through the second AI model 920). The second object information 921 includes information about the one or more objects and may be displayed as "(object class, object position)".

For example, the second AI model 920 may identify a man from the input content image 901, and the second object information 921 related to the Boy may be displayed as "(Boy, Boy's position)". For example, the Boy's position may be represented as "(x1, y1, W1, H1)".

The electronic device 1000 may compare the first object information 911 obtained through the first AI model 910 with the second object information 921 obtained through the second AI model 920, and identify that the one or more objects identified through the first AI model 910 are different from the one or more objects identified through the second AI model 920. For example, when the Girl is identified through the first AI model 910 but not through the second AI model 920, the electronic device 1000 may identify that the one or more objects identified through the first AI model 910 are different from the one or more objects identified through the second AI model 920. Accordingly, the electronic device 1000 may transmit, to the server 2000, the content image 901 and the first object information 911 and second object information 921 related to the content image 901.

In an embodiment of the disclosure, a third AI model 930 installed on the server 2000 may identify one or more objects from the content image 901 received from the electronic device 1000, and output third object information 931 including an object class and an object position corresponding to the identified one or more objects (or information corresponding to the one or more objects identified through the third AI model 930). The third object information 931 includes information about the one or more objects, and may be displayed as "(object class, object position)".

For example, the third AI model 930 may identify a man (or Boy) and a woman (or Girl) from the content image 901, and the third object information 931 related to the Boy may be displayed as "(Boy, Boy's position)", and the third object information 931 related to the Girl may be displayed as "(Girl, Girl's position)". For example, the Boy's position may be represented as "(x1, y1, W1, H1)", and the Girl's position may be represented as "(x2, y2, W2, H2)".

The server 2000 may compare the first object information 911 obtained through the first AI model 910 with the third object information 931 obtained through the third AI model 930, and identify that the one or more objects identified through the first AI model 910 are identical to the one or more objects identified through the third AI model 930. The server 2000 may compare the second object information 921 obtained through the second AI model 920 with the third object information 931 obtained through the third AI model 930, and identify that the one or more objects identified through the second AI model 920 are different from the one or more objects identified through the third AI model 930. In this case, the electronic device 1000 may determine that the content image 901 has a first identification difficulty level of 'Middle'.

The server 2000 may determine an object, which is not identified through the second AI model 920 or is identified as being in a different class than when identified through the second AI model 920 among the one or more objects identified through the third AI model 930, to be an incorrect result region. For example, the server 2000 may determine the 'Girl' that is not identified through the second AI model 920 as the incorrect result region.

Furthermore, in operation S920 of FIG. 9A, when information corresponding to one or more objects identified from the content image through a second AI model is the same as the information corresponding to the one or more objects identified from the content image through the AI model stored in the server 2000, the server 2000 may determine an identification difficulty level of the content image as a second identification difficulty level.

Referring to FIGS. 9A and 9C together, the first AI model 910 may identify a man (or Boy) from the input content image 901, and first object information 912 related to the Boy may be displayed as "(Boy, Boy's position)" and, for example, the Boy's position may be represented as "(x1, y1, W1, H1)". The second AI model 920 may identify the man (or Boy) and a woman (or Girl) from the input content image 901, and second object information 922 related to the Boy may be displayed as "(Boy, Boy's position)" and second object information 922 related to the Girl may be displayed as "(Girl, Girl's position)", and for example, the Boy's position may be represented as "(x1, y1, W1, H1)" and the Girl's position may be represented as "(x2, y2, W2, H2)".

When identifying that the one or more objects identified through the first AI model 910 are different from the one or more objects identified through the second AI model 920, the electronic device 1000 may transmit, to the server 2000, the content image 901 and the first object information 912 and second object information 922 related to the content image 901.

The third AI model 930 may identify a man (or Boy) and a woman (or Girl) from the content image 901 received from the electronic device 1000, and third object information 932 related to the Boy may be displayed as "(Boy, Boy's position)", and third object information 932 related to the Girl may be displayed as "(Girl, Girl's position)". For example, the Boy's position may be represented as "(x1, y1, W1, H1)", and the Girl's position may be represented as "(x2, y2, W2, H2)".

The server 2000 may compare the second object information 922 obtained through the second AI model 920 with the third object information 932 obtained through the third AI model 930, and identify that the one or more objects identified through the second AI model 920 are identical to the one or more objects identified through the third AI model 930. The server 2000 may compare the first object information 912 obtained through the first AI model 910 with the third object information 932 obtained through the third AI model 930, and identify that the one or more objects identified through the first AI model 910 are different from the one or more objects identified through the third AI model 930. In this case, the electronic device 1000 may determine that the content image 901 has a second identification difficulty level of 'Hard'. The second identification difficulty level may be higher than the first identification difficulty level.

The server 2000 may determine an object, which is not identified through the first AI model 910 or is identified differently than when identified through the first AI model 910 among the one or more objects identified through the third AI model 930, to be an incorrect result region. For example, the server 2000 may determine a region corresponding to a bounding box of "Girl", which is not identified through the first AI model 910, as being an incorrect result region.

In operation S930 of FIG. 9A, when a content image corresponding to a training image has the first identification difficulty level, the server 2000 may determine an identification difficulty level of the training image as the first identification difficulty level, and when the content image corresponding to the training image has the second identification difficulty level, the server 2000 may determine an identification difficulty level of the training image as the second identification difficulty level.

In an embodiment of the disclosure, the content image 901 may include a first content image having the first identification difficulty level based on the information corresponding to the one or more objects identified from the content image 901 through the first AI model 910 being the same as the information corresponding to the one or more objects identified from the content image 901 through the third AI model 930 stored in the server 2000, and a second content image having the second identification difficulty level based on the information corresponding to the one or more objects identified from the content image 901 through the second AI model 920 being the same as the information corresponding to the one or more objects identified from the content image 901 through the third AI model 930 stored in the server 2000.

Referring to FIGS. 9B and 9C together, the server 2000 may generate a training image 902, based on the content image 901 and the incorrect result region extracted from the content image 901. Because the operation of generating the training image 902 has been described with reference to FIGS. 8A to 8C, a detailed description thereof may not be repeated here.

In an embodiment of the disclosure, the server 2000 may identify one or more objects from the training image 902 through the third AI model 930, and store information about the one or more objects identified from the training image 902 as a response to (or ground truth for) the object identification in the training image 902. In other words, the server 2000 may identify the one or more objects from the training image 902 through the third AI model 930 in order to obtain ground-truth (or GT) data 904 and 906 regarding the training image 902.

In the disclosure, GT data may be referred to as various terms, such as ground truth, actual measurement data, real-world observation data, correct answer data, true information, observation information, real-world observation information, actual measurement information, or labeled result for data samples. The GT data may be information included in the data samples, information corresponding to the data samples, information associated with the data samples, or information mapped to the data samples. The GT data may be associated with, correspond to, or mapped to one or more labels.

In an embodiment of the disclosure, the GT data 904 and 906 may each be represented as (object class, object position, and object confidence). The server 2000 may obtain class, position, and confidence information of the one or more objects identified from the training image 902 through the third AI model 930. Confidence information represents a probability that an object belongs to a corresponding class and may be expressed as a value between 0 and 1.

For example, the third AI model 930 may identify a man (or Boy) and a woman (or Girl) from the training image 902 input thereto, and object information related to the Boy may be displayed as "(Boy, Boy's position, Boy's confidence)" and object information related to the Girl may be displayed as "(Girl, Girl's position, Girl's confidence)". For example, the Boy's position may be represented as "(x1', y1', W1', H1')", and the Girl's position may be represented as "(x2', y2', W2', H2')". For example, the Boy's confidence C1 may be represented as a value between 0 and 1, and the Girl's confidence C2 may be represented as a value between 0 and 1.

As illustrated in FIG. 9B, when the content image 901 corresponding to the training image 902 has a first identification difficulty level (e.g., Middle), the training image 902 may also be determined to have the first identification difficulty level (e.g., Middle). In this case, the server 2000 may store the training image 902 determined to have the first identification difficulty level in a first identification difficulty dataset (or a Middle dataset) 903.

On the other hand, as illustrated in FIG. 9B, when the content image 901 corresponding to the training image 902 has a second identification difficulty level (e.g., Hard), the training image 902 may also be determined to have the second identification difficulty level (e.g., Hard). In this case, the server 2000 may store the training image 902 determined to have the second identification difficulty level in a second identification difficulty dataset (or a Hard dataset) 905.

In an embodiment of the disclosure, the training image 902 may include a first training image corresponding to the first content image having the first identification difficulty level and a second training image corresponding to the second content image having the second identification difficulty level.

An operation, performed by the server 2000, of training AI models installed on the electronic device 1000 using a stored dataset is described in greater detail below with reference to FIGS. 10A to 10C.

FIG. 10A is a flowchart illustrating an example operation, performed by the server 2000, of training a model, according to various embodiments. FIG. 10B is a flowchart illustrating an example operation, performed by the server 2000, of training a model, according to various embodiments. FIG. 10C is a diagram illustrating an example operation, performed by the server 2000, of training a model, according to various embodiments.

Operation S1010 illustrated in FIG. 10A is a detailed operation of operation S340 of FIG. 3. Operation S1020 illustrated in FIG. 10B is a detailed operation of operation S340 of FIG. 3.

In operation S1010 of FIG. 10A, the server 2000 may train a model corresponding to a first AI model based on each of a first type dataset and a second type dataset that have different ratios between training images with a first identification difficulty level and training images with a second identification difficulty level.

In an embodiment of the disclosure, the electronic device 1000 may receive, from the server 2000, one of a first type AI model and a second type AI model that are respectively trained from the first AI model based on a first type dataset and a second type dataset having different ratios between first training images and second training images.

In operation S1020 of FIG. 10B, the server 2000 may train a model corresponding to a second AI model based on each of a third type dataset and a fourth type dataset that have different ratios between training images with the first identification difficulty level and training images with the second identification difficulty level. In other words, the server 2000 may train each of the first AI model and the second AI model using training images classified into the first identification difficulty level or the second identification difficulty level.

In an embodiment of the disclosure, the electronic device 1000 may receive, from the server 2000, one of a third type AI model and a fourth type AI model that are respectively trained from the second AI model based on a third type dataset and a fourth type dataset having different ratios between first training images and second training images.

Referring to FIGS. 10A to 10C together, in an embodiment of the disclosure, after generating a training image, the server 2000 may determine an identification difficulty level of the generated training image. Based on an identification difficulty level, the server 2000 may classify and store training images into a first identification difficulty dataset 1001 (e.g., a Hard dataset) or a second identification difficulty dataset 1002 (e.g., a Middle dataset).

In an embodiment of the disclosure, the server 2000 may compare (1003) the amount of newly collected dataset with the amount of existing training dataset before performing model training. As used herein, the 'existing training dataset' refers to a training dataset used for pre-training before the first and second AI models are initially distributed to the electronic device 1000. As used herein, the 'newly collected dataset' may refer to a training dataset stored in the server 2000 for updating the first and second AI models after the first and second AI models are distributed to the electronic device 1000. In an embodiment of the disclosure, the 'newly collected dataset' may include training images and GT data newly generated in the server 2000.

When the amount of newly collected data is less than the amount of existing training data, the server 2000 may continue collecting new data without performing model training, until the amount of newly collected dataset exceeds the amount of existing training dataset. When the amount of newly collected dataset is greater than or equal to the amount of existing training dataset, the server 2000 may perform model training using the newly collected dataset. When the amount of newly collected dataset is less than the amount of existing training dataset, the improvement in model performance may be minimal even in the case of training the model using the small amount of newly collected dataset, and thus, the model may be trained only when the amount of newly collected dataset is greater than or at least equal to the amount of existing training dataset.

In an embodiment of the disclosure, the server 2000 may train the first AI model using the newly collected dataset. In order to train the first AI model, the server 2000 may create multiple types of datasets by varying the ratio between the first identification difficulty dataset 1001 (e.g., the Hard dataset) and the second identification difficulty dataset 1002 (e.g., the Middle dataset) stored in the newly collected dataset.

For example, the server 2000 may configure a 1st-1 type dataset 1011 with '40 % Hard dataset and 60 % Middle dataset', a 2nd-1 type dataset 1012 with '60 % Hard dataset and 40 % Middle dataset’, and an N-th-1 type dataset 1013 (N is a natural number of 3 or greater) with '90 % Hard dataset and 10 % Middle dataset’. FIG. 10C illustrates there are three or more types of datasets for training the first AI model, but this is only an example, and the number of types of datasets is not limited thereto. Moreover, in the disclosure, two types of datasets arbitrarily set among the 1st-1 type dataset 1011 to the N-th-1 type dataset 1013 may be referred to as a first type dataset and a second type dataset, respectively.

In an embodiment of the disclosure, the server 2000 may train the second AI model using the newly collected dataset. Similar to when training the first AI model, to train the second AI model, the server 2000 may set multiple types of datasets by varying the ratio between the first identification difficulty dataset 1001 (e.g., the Hard dataset) and the second identification difficulty dataset 1002 (e.g., the Middle dataset) stored in the newly collected dataset.

For example, the server 2000 may configure a 1st-2 type dataset 1021 with '40 % Hard dataset and 60 % Middle dataset', a 2nd-2 type dataset 1022 with '60 % Hard dataset and 40 % Middle dataset’, and an N-th-1 type dataset 1023 (N is a natural number of 3 or greater) with '90 % Hard dataset and 10 % Middle dataset’. FIG. 10C illustrates there are three or more types of datasets for training the second AI model, but this is only an example, and the number of types of datasets is not limited thereto. Moreover, in the disclosure, two types of datasets arbitrarily set among the 1st-2 type dataset 1021 to the N-th-2 type dataset 1023 may be referred to as a third type dataset and a fourth type dataset, respectively.

In an embodiment of the disclosure, when it is determined as a result of the model training that an update of the first AI model and/or the second AI model is necessary, the server 2000 may transmit information corresponding to the update of the first AI model and/or the second AI model to the electronic device 1000.

For example, when training the first AI model, the server 2000 may perform 1st-1 type model training 1031 based on the 1st-1 type dataset 1011, 2nd-1 type model training 1032 based on the 2nd-1 type dataset 1012, and N-th-1 type model training 1033 based on the N-th-1 type dataset 1013.

In an embodiment of the disclosure, the server 2000 may obtain an updated version of the first AI model itself as a result of the 1st-1 training 1031, an updated version of the first AI model itself obtained as a result of the 2nd-1 model training 1032, and an updated version of the first AI model itself as a result of the N-th-1 type model training 1033. In the disclosure, any two of the updated versions of the first AI model itself obtained as a result of the 1st-1 type model training 1031, the 2nd-1 type model training 1032, and the N-th-1 type model training 1033 may be referred to as a first type AI model and a second type AI model, respectively.

In an embodiment of the disclosure, the server 2000 may store, in a model storage 1004, the updated versions of the first AI model itself obtained as a result of the 1st-1 type model training 1031, the 2nd-1 type model training 1032, and the N-th-1 type model training 1033. The server 2000 may distribute, to the electronic device 1000, a model with high performance among updated versions of the first AI model obtained as a result of each type of model training.

In an embodiment of the disclosure, the server 2000 may obtain updated parameter information as a result of the 1st-1 model training 1031, updated parameter information as a result of the 2nd-1 type model training 1032, and updated parameter information as a result of the N-th-1 type model training 1033, and store the pieces of updated parameter information in the model storage 1004. The server 2000 may transmit, to the electronic device 1000, updated parameter information exhibiting high performance among the pieces of updated parameter information obtained as a result of each type of model training. The electronic device 1000 may receive the updated parameter information and update the first AI model.

For example, when training the second AI model, the server 2000 may perform 1st-2 type model training 1041 based on the 1st-2 type dataset 1021, 2nd-2 type model training 1042 based on the 2nd-2 type dataset 1022, and N-th-2 type model training 1043 based on the N-th-2 type dataset 1023.

In an embodiment of the disclosure, the server 2000 may obtain an updated version of the second AI model itself as a result of the 1st-2 training 1041, an updated version of the second AI model itself as a result of the 2nd-2 model training 1042, and an updated version of the second AI model itself as a result of the N-th-2 type model training 1043. In the disclosure, any two of the updated versions of the second AI model itself obtained as a result of the 1st-2 type model training 1041, the 2nd-2 type model training 1042, and the N-th-2 type model training 1043 may be referred to as a third type AI model and a fourth type AI model, respectively.

A method by which the server 2000 trains the second AI model and transmits information about an update of the second AI model is similar to the method by which the server 2000 trains the first AI model and transmits information about the update of the first AI model, so a detailed description thereof may not be repeated here.

A method of updating an AI model installed on the electronic device 1000 after model training is described in greater detail below with reference to FIGS. 11A and 11B.

FIG. 11A is a flowchart illustrating an example operation, performed by the server 2000, of distributing models to multiple electronic devices 1000, according to various embodiments. FIG. 11B is a diagram illustrating an example operation, performed by the server 2000, of distributing models to the multiple electronic devices 1000, according to various embodiments.

In operation S1110 of FIG. 11A, the server 2000 may store a first type AI model trained based on the first type dataset and a second type AI model trained based on the second type dataset. Because the description of operation S1110 has been provided with reference to FIG. 10B, a detailed description may not be repeated here.

In operation S1120 of FIG. 11A, the server 2000 may distribute the first type AI model to some of the at least one electronic device 1000, and the second type AI model to others of the at least one electronic device 1000.

In an embodiment of the disclosure, the at least one electronic device 1000 may receive, from the server 2000, one of the first type AI model and the second type AI model that are respectively trained from the first AI model based on the first type dataset and the second type dataset having different ratios between first training images and second training images.

Referring to FIGS. 11A and 11B together, the server 2000 may perform data communication with the plurality of electronic devices 1000. The server 2000 may perform testing of candidate models via some electronic devices before transmitting information about an update (e.g., distributing an updated version of model) to all of the electronic devices 1000 that communicate with the server 2000. The server 2000 may distribute candidate models stored in the model storage 1111 to some electronic devices.

For example, the server 2000 may distribute a first type AI model 1101, which is trained based on a first type dataset, to electronic devices 1000a (hereinafter referred to as first group electronic devices 1000a) that account for 10% of all the electronic devices 1000. The first group electronic devices 1000a may test (1103) the object recognition performance for input content images using the distributed first type AI model 1101. For example, the server 2000 may distribute a second type AI model 1102, which is trained based on a second type dataset, to electronic devices 1000b (hereinafter referred to as second group electronic devices 1000b) that account for another 10% of all the electronic devices 1000. The second group electronic devices 1000b may test (1104) the object recognition performance for the input content images using the distributed second type AI model 1102. Among all of the electronic devices 1000, the remaining electronic devices 1000c, excluding the first group and second group electronic devices 1000a and 1000b, may test (1105) the object recognition performance for the input content images using the first AI model that is already installed.

In an embodiment of the disclosure, the at least one electronic device 1000 may deliver (or transmit) a test result of one of the first type AI model 1101 or the second type AI model 1102 to the server 2000.

In operation S1130 of FIG. 11A, the server 2000 may receive information about a test result of the first type AI model from some of the at least one electronic device 1000. In operation S1140 of FIG. 11A, the server 2000 may receive information about a test result of the second type AI model from others of the at least one electronic device 1000. In operation S1150 of FIG. 11A, the server 2000 may receive information about a test result of the first AI model from the remaining electronic devices, excluding some and others of the at least one electronic device 1000.

Referring to FIGS. 11A and 11B together, the first group electronic devices 1000a may transmit test result data 1106 of the first type AI model 1101 to the server 2000, the second group electronic devices 1000b transmit test result data 1107 of the second type AI model 1102 to the server 2000, and the remaining electronic devices 1000c may transmit test result data 1108 of the existing model to the server 2000. For example, the server 2000 may receive the test result data 1106 of the first type AI model 1101 from the first group electronic devices 1000a, the test result data 1107 of the second type AI model 1102 from the second group electronic devices 1000b, and the test result data 1108 of the existing model from the remaining electronic devices 1000c. For example, test result data may include Intersection over Union (IoU), which is an indicator for measuring the extent to which a predicted bounding box overlaps with an actual (ground truth) bounding box, Precision, which indicates a proportion of objects that are actually correct among objects predicted by a model, Recall, which indicates a proportion of objects recognized by the model among objects that actually exist, and mean Average Precision (mAP), which is an indicator that comprehensively evaluates the Precision and Recall of the model.

In operation S1160 of FIG. 11A, the server 2000 may determine a final model from among the first AI model, the first type AI model, and the second type AI model, based on the information about the test result of the first type AI model, the information about the test result of the second type AI model, and the information about the test result of the first AI model.

In operation S1170 of FIG. 11A, when the determined final model is the first type AI model or the second type AI model, the server 2000 may distribute the determined first type AI model or second type AI model to all of the at least one electronic device 1000.

In an embodiment of the disclosure, the at least one electronic device 1000 may receive, from the server 2000, information corresponding to the final model determined from among the first AI model, the first type AI model, and the second type AI model based on the test result of the one of the first type AI model and the second type AI model. For example, the at least one electronic device 1000 may receive, from the server 2000, information corresponding to the final model determined from among the first AI model, the first type AI model, and the second type AI model, based on the test result of the first AI model, the test result of the first type AI model, and the test result of the second type AI model. In an embodiment of the disclosure, the at least one electronic device 1000 may update the first AI model based on the received information corresponding to the final model.

Referring to FIGS. 11A and 11B together, for example, the server 2000 may determine that a test result of the first type AI model 1101 shows the best performance by referring to the test result data 1106 of the first type model, the test result data 1107 of the second type AI model 1102, and the test result data 1108 of the existing model. Accordingly, the server 2000 may determine (1109) the first type AI model 1101 as the final model.

In an embodiment of the disclosure, the server 2000 may determine (1110) whether the determined final model is the first type AI model 1101 or the second type AI model 1102. When the determined final model is the first type AI model 1101 or the second type AI model 1102, the server 2000 may distribute the final model to all of the electronic devices 1000. On the other hand, when the determined final model is an existing model that is neither the first type AI model 1101 nor the second type AI model 1102, the server 2000 may delete the first type AI model 1101 and the second type AI model 1102 newly stored in the model storage 1111.

Although FIG. 11B illustrates an example in which the server 2000 distributes the updated version of model itself, the disclosure is not limited thereto, and the server 2000 may transmit the updated parameter information to the electronic device 1000, and the electronic device 1000 may update the parameters of the existing model based on the received parameter information.

Although a method of updating the AI models installed on the electronic device 1000 based on the first AI model is described with reference to FIGS. 11A and 11B, this may also be applied similarly to a method of updating the AI models installed on the electronic device 1000 based on the second AI model.

In an embodiment of the disclosure, the server 2000 may store a third type AI model trained based on a third type dataset and a fourth type AI model trained based on a fourth type dataset.

In an embodiment of the disclosure, the server 2000 may distribute the third type AI model to some of the at least one electronic device 1000 and the fourth type AI model to others of the at least one electronic device 1000.

In an embodiment of the disclosure, the at least one electronic device 1000 may receive, from the server 2000, one of the third type AI model and the fourth type AI model that are respectively trained from the second AI model based on the third type dataset and the fourth type dataset having different ratios between third training images and fourth training images.

In an embodiment of the disclosure, the server 2000 may receive information about a test result of the third type AI model from some of the at least one electronic device 1000. In an embodiment of the disclosure, the server 2000 may receive information about a test result of the fourth type AI model from others of the at least one electronic device 1000. In an embodiment of the disclosure, the server 2000 may receive information about a test result of the second AI model from the remaining electronic devices, excluding some and others of the at least one electronic device 1000.

In an embodiment of the disclosure, the server 2000 may determine a final model from among the second AI model, the third type AI model, and the fourth type AI model, based on the information about the test result of the third type AI model, the information about the test result of the fourth type AI model, and the information about the test result of the second AI model.

In an embodiment of the disclosure, when the determined final model is the third type AI model or the fourth type AI model, the server 2000 may distribute the determined third type AI model or fourth type AI model to all of the at least one electronic device 1000.

In an embodiment of the disclosure, the at least one electronic device 1000 may receive, from the server 2000, information corresponding to the final model determined from among the second AI model, the third type AI model, and the fourth type AI model, based on the test result of one of the third type AI model and the fourth type AI model. For example, the at least one electronic device 1000 may receive, from the server 2000, information corresponding to the final model determined from among the second AI model, the third type AI model, and the fourth type AI model, based on the test result of the second AI model, the test result of the third type AI model, and the test result of the fourth type AI model. In an embodiment of the disclosure, the at least one electronic device 1000 may update the second AI model based on the received information corresponding to the final model.

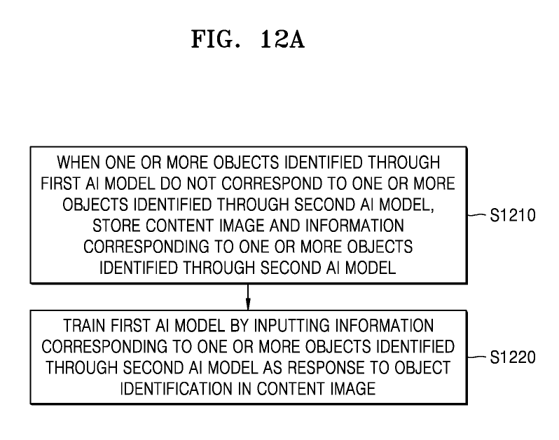

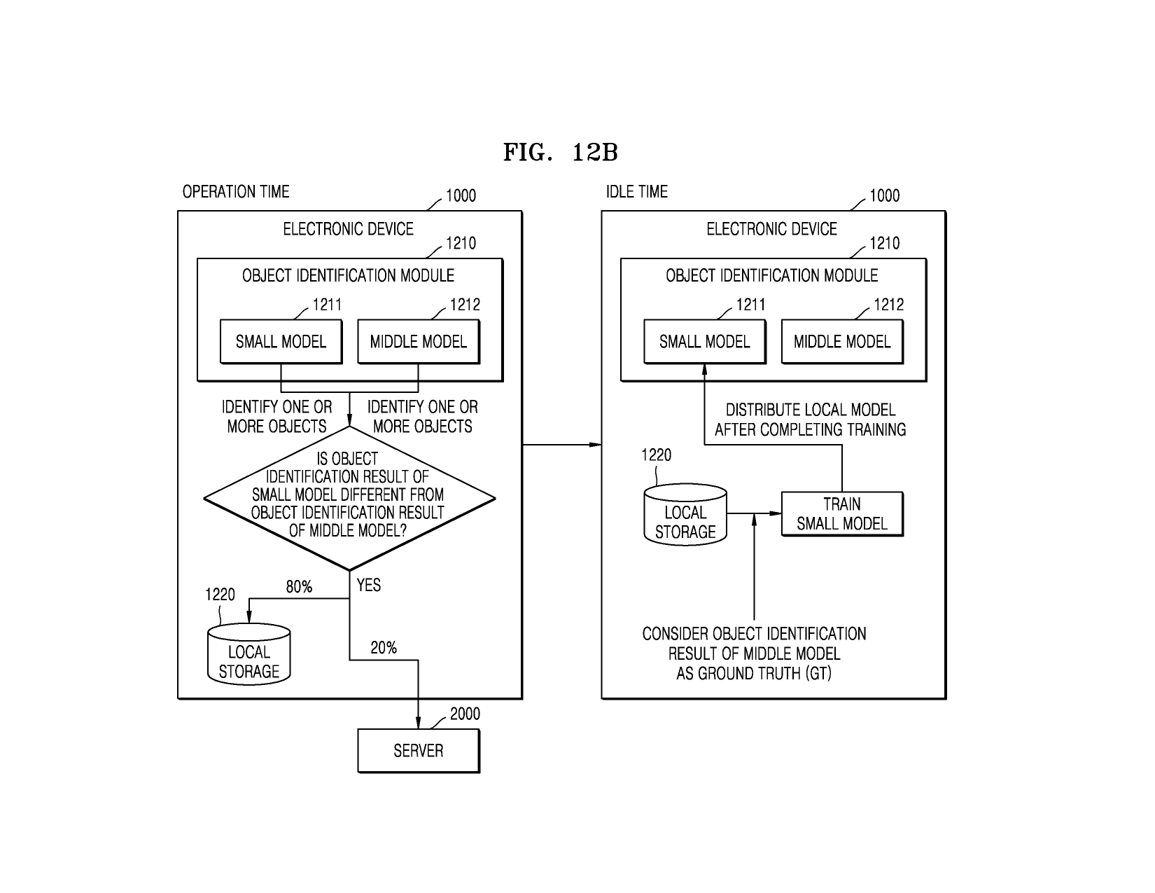

FIG. 12A is a flowchart illustrating an example operation, performed by the electronic device 1000, of training a model, according to various embodiments. FIG. 12B is a diagram illustrating an example operation, performed by the electronic device 1000, of training a model, according to various embodiments.

In operation S1210 of FIG. 12A, according to an embodiment of the disclosure, when one or more objects identified through a first AI model do not correspond to one or more objects identified through a second AI model, the electronic device 1000 may store a content image and information corresponding to the one or more objects identified through the second AI model. Based on the one or more objects identified through the first AI model not corresponding to the one or more objects identified through the second AI model, the electronic device 1000 may store the content image and the information corresponding to the one or more objects identified through the second AI model.

Referring to FIGS. 12A and 12B together, in an embodiment of the disclosure, the object identification module 1210 in the electronic device 1000 may include the first AI model corresponding to a small model 1211 and the second AI model corresponding to a middle model 1212. Hereinafter, the description will be based on the assumption that the first AI model is the small model 1211 and the second AI model is the middle model 1212. At the time of operation for providing content images, the electronic device 1000 may perform object identification from multiple input content images by using the small model 1211, and perform object identification from the multiple input content images using the middle model 1212.

When object identification results of the small model 1211 for specific content images are different from object identification results of the middle model 1212 therefor, the electronic device 1000 may store some (e.g., 80 %) of the specific content images in a local storage 1220 within the electronic device 1000, and transmit the rest (e.g., 20 %) of the specific content images to the server 2000.

The electronic device 1000 may then store, in the local storage 1220 within the electronic device 1000, one group of the specific content images and information about objects identified from the one group of the content images through the middle model 1212. The electronic device 1000 may transmit, to the server 2000, the remaining specific content images, information about objects identified from the remaining content images through the small model 1211, and information about objects identified from the remaining content images through the middle model 1212. Information about an object may include object class information and object position information.

In operation S1220 of FIG. 12A, the electronic device 1000 may train the first AI model by inputting the information corresponding to the one or more objects identified through the second AI model as a response to (or ground truth for) object identification in the content image.

Referring to FIGS. 12A and 12B together, the electronic device 1000 may train the small model 1211 while not performing an operation such as providing images. The electronic device 1000 may train the small model 1211 using content images stored in the local storage 1220. The electronic device 1000 may train the small model 1211 by inputting information about objects identified through the middle model 1212, which is stored in the local storage 1220, as a response to (or ground truth for) a corresponding content image.

When it is determined that that an update of the small model 1211 is necessary during the process of training the small model 1211, the electronic device 1000 may transmit information about the update to the small model 1211. For example, the electronic device 1000 may transmit, to the small model 1211, updated parameter information or an updated version of the model itself.

According to an embodiment of the disclosure, by training the small model 1211 inside the electronic device 1000, a large amount of data may not be transmitted to the server 2000 for model training. Furthermore, by training the small model 1211 within the electronic device 1000, the electronic device 1000 may train the small model 1211 using the input content images as they are.

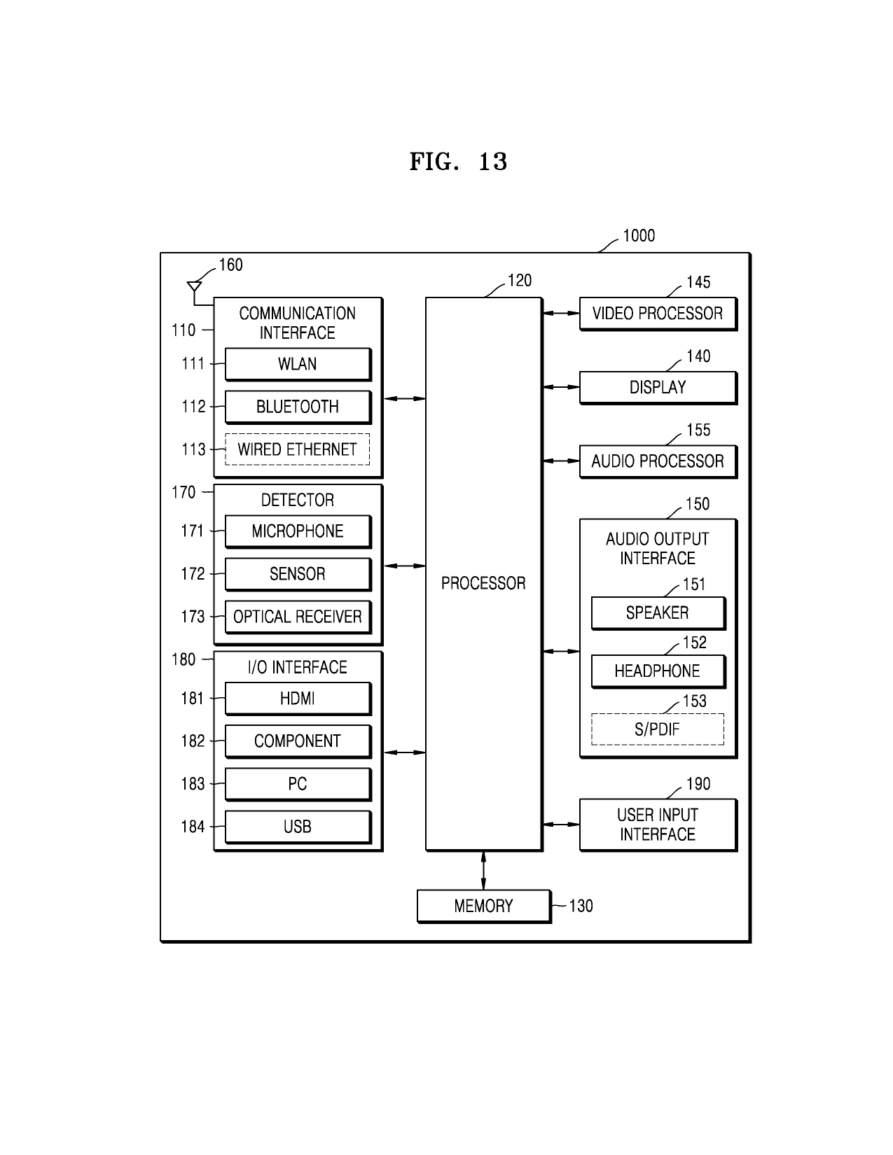

FIG. 13 is a block diagram illustrating an example configuration of the electronic device 1000 according to various embodiments.

Referring to FIG. 13, according to an embodiment of the disclosure, the electronic device 1000 may include a communication interface (e.g., including communication circuitry) 110, a processor (e.g., including processing circuitry) 120, a memory 130, a display 140, a video processor (e.g., including various circuitry and/or executable program instructions) 145, a tuner 160, an audio processor (e.g., including various circuitry and/or executable program instructions) 155, an audio output interface (e.g., including circuitry) 150, a detector (e.g., including circuitry) 170, an input/output (I/O) interface (e.g., including various circuitry) 180, and a user input interface (e.g., including user interface circuitry) 190. However, all of the components illustrated in FIG. 13 are not essential components. The electronic device 1000 may be implemented with more or fewer components than those illustrated in FIG. 13.

The memory 130 may store instructions, algorithms, data structures, program code, and application programs for processing and control by the processor 120, and store data input to or output from the electronic device 1000. The memory 130 may include at least one type of storage medium, e.g., at least one of a flash memory-type memory, a hard disk-type memory, a multimedia card micro-type memory, a card-type memory (e.g., an SD card or an xD memory), RAM, SRAM, ROM, EEPROM, PROM, mask ROM, flash ROM, a hard disk drive (HDD), or a solid state drive (SSD). A program (one or more instructions) or an application stored in the memory 130 may be executed by the processor 120.

The tuner 160 may tune and then select only a frequency of a channel to be received by the electronic device 1000 from among many radio wave components by performing amplification, mixing, resonance, etc. of broadcast content received by wire or wirelessly. A broadcast signal received via the tuner 160 is separated into audio, video, and additional information (e.g., an electronic program guide (EPG)). The audio, video, and additional information may be stored in the memory 130 according to control by the processor 120.

The tuner 160 may receive broadcast signals from various sources such as terrestrial broadcasting, cable broadcasting, satellite broadcasting, Internet broadcasting, etc. The tuner 160 may also receive broadcast signals from sources such as analog broadcasting, digital broadcasting, or the like.

The communication interface 110 may include various communication circuity and connect the electronic device 1000 to a peripheral device, an external device, a server, a display device, a remote control device, a mobile terminal, etc. under the control of the processor 120. The communication interface 110 may include at least one communication module capable of performing wireless communication. For example, the communication interface 110 may separately include a communication module for communicating with a server, a communication module for communicating with a display device, a communication module for communicating with a remote control device, and a communication module for communicating with a mobile terminal, or may include a single integrated module.

The communication interface 110 may include at least one of a wireless local area network (WLAN) module 111, a Bluetooth module 112, or a wired Ethernet 113 depending on the performance and structure of the electronic device 1000. The Bluetooth module 112 may receive Bluetooth signals transmitted from a peripheral device according to the Bluetooth communication standard. The Bluetooth module 112 may be a Bluetooth Low Energy (BLE) communication module and receive BLE signals. The Bluetooth module 112 may continuously or temporarily scan for BLE signals to detect whether a BLE signal is being received. The WLAN module 111 may transmit and receive Wi-Fi signals to and from peripheral devices according to the Wi-Fi communication standard.

The detector (or detection interface) 170 may include various circuitry and/or electronic components and detects a user's voice, images, or interactions and may include a microphone 171, a sensor 172, and an optical receiver 173.

The microphone 171 may receive an audio signal including speech uttered by the user or noise, and convert the received audio signal into an electrical signal and output the electrical signal to the processor 120.

The microphone 171 may also be provided in a remote control device such as a remote control, a mobile terminal, or an AI speaker. For example, the mobile terminal may execute an application for remotely controlling the electronic device 1000. In this case, the microphone 171 provided in the remote control device may receive an audio signal including speech uttered by the user or noise. The remote control device may convert the audio signal into a control signal and transmit the control signal to the electronic device 1000. The electronic device 1000 may receive the control signal from the remote control device via the communication interface 110.

In an embodiment of the disclosure, the electronic device 1000 may transmit the received speech signal to an external server (e.g., a speech-to-text (STT) server). The external server may generate text from the received speech signal. The external server may transmit text information corresponding to the user's speech back to the electronic device 1000 or to another server. The electronic device 1000 may receive the text information corresponding to the user's speech from the external server. Moreover, the disclosure is not limited thereto, and the electronic device 1000 may convert a speech signal received within the electronic device 1000 into text to thereby generate text information corresponding to the user's speech. The electronic device 1000 may directly use text information it has generated on its own, or transmit the text information to another external server.

The sensor 172 may detect the user's image, or the user's interaction, gesture, touch, etc., and may include a distance sensor, an image sensor, a gesture sensor, an ambient light sensor, etc. The distance sensor may include various types of sensors for detecting a distance between the electronic device 1000 and the user, such as an ultrasound sensor, an infrared radiation (IR) sensor, and a time of flight (TOF) sensor. The distance sensor may detect a distance from the user and transmit sensing data to the processor 120. The image sensor may capture an image of the user's gesture through a camera or the like, and transmit the captured image to the processor 120. The gesture sensor may detect a movement speed or direction through an accelerometer or gyroscope. The ambient light sensor may detect an ambient light level.

The optical receiver 173 may include various circuitry and receive an optical signal (including a control signal). The optical receiver 173 may receive an optical signal corresponding to a user input (e.g., touch, press, touch gesture, speech (or voice), or motion) from a control device such as a remote control or mobile phone.

Under control of the processor 120, the I/O interface 180 may receive video (e.g., dynamic image signals or still image signals), audio (e.g., speech signals, music signals, etc.), and additional information from an external device, etc. The I/O interface 180 may include ports for outputting video and audio together, or ports for outputting video and audio separately.

The I/O interface 180 may include various circuitry including one of a High-Definition Multimedia Interface (HDMI) port 181, a component jack 182, a PC port 183, and a Universal Serial Bus (USB) port 184. The I/O interface 180 may include a combination of the HDMI port 181, the component jack 182, the PC port 183, and the USB port 184. Furthermore, the I/O interface 180 may include one of a DisplayPort (DP), a Thunderbolt port, a Video Graphics Array (VGA) port, a red, green, and blue (RGB) port, a D-Subminiature (D-Sub), and a Digital Visual Interface (DVI).

When the electronic device 1000 corresponds to a content provision device such as a set-top box, the I/O interface 180 may output video, audio, and additional information to a display device according to control by the processor 120.

In an embodiment of the disclosure, image data and speech data are transmitted through separate ports within the I/O interface 180, and may be stored in separate tracks in the electronic device 1000. For example, the image data may be transmitted via ports such as VGA and DVI, and the speech data may be transmitted via separate ports. Alternatively, the image data and the speech data may be transmitted as a single stream via HDMI, DP, Thunderbolt, etc., and stored as separate tracks in the electronic device 1000.

The video processor 145 may include various circuitry and/or executable program instructions and process image data to be displayed by the display 140 and perform various image processing operations, such as decoding, rendering, scaling, noise filtering, frame rate conversion, resolution conversion, etc., on the image data.

The display 140 may output, on a screen, content received from a broadcasting station, or an external device such as an external server, an external storage medium, or the like. The content may include, as a media signal, a video signal, an audio signal, a text signal, etc.

The audio processor 155 may include various circuitry and/or executable program instructions and process audio data. The audio processor 155 may perform various types of processing, such as decoding, amplification, noise removal, etc., on the audio data.

The audio output interface 150 may include various circuitry and output, according to control by the processor 120, audio contained in content received via the tuner 160, audio input via the communication interface 110 or the I/O interface 180, and audio stored in the memory 130. The audio output interface 150 may include at least one of a speaker 151, a headphone 152, or a Sony/Phillips Digital Interface (S/PDIF) output terminal 153.

The user input interface 190 may include various user interface circuitry and receive a user input for controlling the electronic device 1000. The user input interface 190 may include, but is not limited to, various types of user input devices including a touch panel for sensing the user's touch, a button for receiving the user's push manipulation, a wheel for receiving the user's rotation manipulation, a keyboard, a dome switch, a microphone for speech recognition, a motion detection sensor for sensing a motion, etc. When a remote control, such as a remote control device, or other mobile terminals controls the electronic device 1000, the user input interface 190 may receive a control signal received from the remote control device.

According to an example embodiment of the disclosure, an electronic device 1000 is provided.

According to an example embodiment of the disclosure, the electronic device 1000 may include a communication interface 110, memory 130 storing a plurality of instructions, and at least one processor, comprising processing circuitry, 120 operatively coupled to the memory 130 and including processing circuitry.

According to an example embodiment of the disclosure, the at least one processor 120 individually or collectively may execute the instructions to cause the electronic device 1000 to identify, based on a content image input to the electronic device 1000, one or more objects through each of a first AI model and a second AI model. According to an embodiment of the disclosure, the at least one processor 120 individually or collectively may execute the instructions to cause the electronic device 1000 to, when the one or more objects identified through the first AI model from the content image do not correspond to the one or more objects identified from the content image through the second AI model, transmit, to a server, via the communication interface 110, the content image, information corresponding to the one or more objects identified through the first AI model, and information corresponding to the one or more objects identified through the second AI model. According to an embodiment of the disclosure, the at least one processor 120 individually or collectively may execute the instructions to cause the electronic device 1000 to receive, from the server, via the communication interface 110, information corresponding to an update of at least one of the first AI model or the second AI model, which is obtained using a training image generated based on the content image, the information corresponding to the one or more objects identified through the first AI model, and the information corresponding to the one or more objects identified through the second AI model.

According to an example embodiment of the disclosure, the at least one processor 120 individually or collectively may execute the instructions to cause the electronic device 1000 to receive an input corresponding to object identification for each of a plurality of content images. According to an embodiment of the disclosure, the at least one processor 120 individually or collectively may execute the instructions to cause the electronic device 1000 to, when a resolution of each of the plurality of content images is less than a threshold value, execute each of the first AI model and the second AI model according to the receiving of the input corresponding to the object identification, and when the resolution of each of the plurality of content images is greater than or equal to the threshold value, execute the first AI model according to the receiving of the input corresponding to the object identification and execute the second AI model based on a defined frequency.

According to an example embodiment of the disclosure, the at least one processor 120 individually or collectively may execute the instructions to cause the electronic device 1000 to receive an input corresponding to object identification for each of a plurality of content images. According to an embodiment of the disclosure, the at least one processor 120 individually or collectively may execute the instructions to cause the electronic device 1000 to alternately execute the first AI model and the second AI model according to the receiving of the input corresponding to the object identification. According to an embodiment of the disclosure, the at least one processor 120 individually or collectively may execute the instructions to cause the electronic device 1000 to execute both the first AI model and the second AI model when frequencies of execution of the first AI model and the second AI model correspond to a defined frequency.

According to an example embodiment of the disclosure, the at least one processor 120 individually or collectively may execute the instructions to cause the electronic device 1000 to, when the one or more objects identified through the first AI model do not correspond to the one or more objects identified through the second AI model, store the content image and the information corresponding to the one or more objects identified through the second AI model. According to an embodiment of the disclosure, the at least one processor 120 individually or collectively may execute the instructions to cause the electronic device 1000 to train the first AI model by inputting the information corresponding to the one or more objects identified through the second AI model as a response to the object identification in the content image.

According to an example embodiment of the disclosure, the information corresponding to the update of the at least one of the first AI model or the second AI model may include at least one of a model that is obtained by updating the first AI model based on the training image and information corresponding to one or more objects identified from the training image through the server or a model that is obtained by updating the second AI model based on the training image and the information corresponding to the one or more objects identified from the training image through the server.

According to an example embodiment of the disclosure, the training image may be based on the content image and an incorrect result region corresponding to an object identified differently by the electronic device 1000 and the server.

According to an example embodiment of the disclosure, the training image may correspond to an image obtained by specifying, based on a second feature prompt corresponding to the incorrect result region, a base image based on a first feature prompt corresponding to a remaining region of the content image other than the incorrect result region.

According to an example embodiment of the disclosure, the content image may include a first content image having a first identification difficulty level based on the information corresponding to the one or more objects identified from the content image through the first AI model being the same as information corresponding to one or more objects identified from the content image through an AI model stored in the server, and a second content image having a second identification difficulty level based on the information corresponding to the one or more objects identified from the content image through the second AI model being the same as the information corresponding to the one or more objects identified from the content image through the AI model stored in the server. According to an embodiment of the disclosure, the training image may include a first training image corresponding to the first content image having the first identification difficulty level and a second training image corresponding to the second content image having the second identification difficulty level.

According to an example embodiment of the disclosure, the at least one processor 120 individually or collectively may execute the instructions to cause the electronic device 1000 to receive, from the server, one of a first type AI model and a second type AI model that are trained from the first AI model respectively based on a first type dataset and a second type dataset having different ratios between the first training image and the second training image.

According to an example embodiment of the disclosure, the at least one processor 120 individually or collectively may execute the instructions to cause the electronic device 1000 to transmit a test result of one of the first type AI model and the second type AI model to the server.

According to an example embodiment of the disclosure, the at least one processor 120 individually or collectively may execute the instructions to cause the electronic device 1000 to receive, from the server, information corresponding to a final model determined from among the first AI model, the first type AI model, and the second type AI model, based on the test result of the one of the first type AI model and the second type AI model. According to an embodiment of the disclosure, the at least one processor 120 individually or collectively may execute the instructions to cause the electronic device 1000 to update the first AI model based on the received information corresponding to the final model.

According to an example embodiment of the disclosure, a server 2000 is provided.

According to an embodiment of the disclosure, the server 2000 may include a communication interface 210 communicating with at least one electronic device, at least one processor, comprising processing circuitry, 220, and memory 230 storing a plurality of instructions.

According to an example embodiment of the disclosure, the at least one processor 220 individually or collectively may execute the instructions to cause the server 2000 to receive, from the at least one electronic device, a content image and information about one or more objects identified from the content image through one or more AI models stored in the at least one electronic device.

According to an example embodiment of the disclosure, the at least one processor 220 individually or collectively may execute the instructions to cause the server 2000 to identify one or more objects from the content image through an AI model stored in the server 2000, and extract, from the content image, an incorrect result region corresponding to an object identified differently by the at least one electronic device and the server 2000.

According to an example embodiment of the disclosure, the at least one processor 220 individually or collectively may execute the instructions to cause the server 2000 to generate a training image based on the content image and the incorrect result region and store the training image.

According to an example embodiment of the disclosure, the at least one processor 220 individually or collectively may execute the instructions to cause the server 2000 to train the AI models stored in the at least one electronic device using the stored training image.

According to an example embodiment of the disclosure, the at least one processor 220 individually or collectively may execute the instructions to cause the server 2000 to generate a base image based on features extracted from the remaining region of the content image other than the incorrect result region.

According to an example embodiment of the disclosure, the at least one processor 220 individually or collectively may execute the instructions to cause the server 2000 to generate the training image by specifying the base image based on features extracted from the incorrect result region in the content image.

According to an example embodiment of the disclosure, the at least one processor 220 individually or collectively may execute the instructions to cause the server 2000 to generate a first feature prompt corresponding to the remaining region of the content image.

According to an example embodiment of the disclosure, the at least one processor 220 individually or collectively may execute the instructions to cause the server 2000 to generate a base image based on the first feature prompt.

According to an example embodiment of the disclosure, the at least one processor 220 individually or collectively may execute the instructions to cause the server 2000 to generate a second feature prompt corresponding to the incorrect result region in the content image.

According to an example embodiment of the disclosure, the at least one processor 220 individually or collectively may execute the instructions to cause the server 2000 to generate, based on the second feature prompt, a training image from the base image.

According to an example embodiment of the disclosure, the at least one processor 220 individually or collectively may execute the instructions to cause the server 2000 to identify one or more objects from the training image through the AI model stored in the server 2000, and store information corresponding to the one or more objects identified from the training image as a response to (or ground truth for) the object identification in the training image.

According to an example embodiment of the disclosure, the at least one processor 220 individually or collectively may execute the instructions to cause the server 2000 to determine an identification difficulty level of the content image as a first identification difficulty level when information corresponding to one or more objects identified from the content image through a first AI model is the same as (or corresponds to) information corresponding to the one or more objects identified from the content image through the AI model stored in the server 2000.

According to an example embodiment of the disclosure, the at least one processor 220 individually or collectively may execute the instructions to cause the server 2000 to determine an identification difficulty level of the content image as a second identification difficulty level when information corresponding to one or more objects identified from the content image through a second AI model is the same as (or corresponds to) the information corresponding to the one or more objects identified from the content image through the AI model stored in the server 2000.

According to an example embodiment of the disclosure, the at least one processor 220 individually or collectively may execute the instructions to cause the server 2000 to, when a content image corresponding to a training image has the first identification difficulty level, determine an identification difficulty level of the training image as the first identification difficulty level, and when a content image corresponding to a training image has the second identification difficulty level, determine an identification difficulty level of the training image as the second identification difficulty level.

According to an example embodiment of the disclosure, the at least one processor 220 individually or collectively may execute the instructions to cause the server 2000 to train models corresponding to the first AI model respectively based on a first type dataset and a second type dataset that have different ratios between training images with the first identification difficulty level and training images with the second identification difficulty level.

According to an example embodiment of the disclosure, the at least one processor 220 individually or collectively may execute the instructions to cause the server 2000 to store a first type AI model trained based on the first type dataset and a second type AI model trained based on the second type dataset.

According to an example embodiment of the disclosure, the at least one processor 220 individually or collectively may execute the instructions to cause the server 2000 to distribute the first type AI model to one group of the at least one electronic device and the second type AI model to others of the at least one electronic device.

According to an example embodiment of the disclosure, the at least one processor 220 individually or collectively may execute the instructions to cause the server 2000 to receive information about a test result of the first type AI model from the one group of the at least one electronic device.

According to an example embodiment of the disclosure, the at least one processor 220 individually or collectively may execute the instructions to cause the server 2000 to receive information about a test result of the second type AI model from another group of the at least one electronic device.

According to an example embodiment of the disclosure, the at least one processor 220 individually or collectively may execute the instructions to cause the server 2000 to receive information about a test result of the first AI model from the remaining electronic devices, excluding the one group and the other group of the at least one electronic device.

According to an example embodiment of the disclosure, the at least one processor 220 individually or collectively may execute the instructions to cause the server 2000 to determine a final model from among the first AI model, the first type AI model, and the second type AI model, based on the information about the test result of the first type AI model, the information about the test result of the second type AI model, and the information about the test result of the first AI model.

According to an example embodiment of the disclosure, the at least one processor 220 individually or collectively may execute the instructions to cause the server 2000 to, when the determined final model is the first type AI model or the second type AI model, distribute the determined first type AI model or second type AI model to all of the at least one electronic device.

According to an example embodiment of the disclosure, the at least one processor 220 individually or collectively may execute the instructions to cause the server 2000 to train models corresponding to the second AI model respectively based on a third type dataset and a fourth type dataset that have different ratios between training images with the first identification difficulty level and training images with the second identification difficulty level.

According to an example embodiment of the disclosure, the content image received from the at least one electronic device may correspond to an image in which the one or more objects identified through the first AI model are different from the one or more objects identified through the second AI model.

According to an example embodiment of the disclosure, a system 100 is provided.

In an example embodiment of the disclosure, the system 100 may include at least one electronic device 1000 and a server 2000. According to an embodiment of the disclosure, each of the at least one electronic device 1000 may include a communication interface 110 communicating with the server 2000, at least one processor, comprising processing circuitry, 120, and memory 130 storing a plurality of instructions. According to an embodiment of the disclosure, the server 2000 may include a communication interface 210 communicating with the at least one electronic device 1000, at least one processor 220, and memory 230 storing a plurality of instructions.

In an example embodiment of the disclosure, the at least one processor 120 individually or collectively may execute the instructions to cause the at least one electronic device 1000 to identify one or more objects from a content image input thereto using each of a first AI model and a second AI model.

In an example embodiment of the disclosure, the at least one processor 120 individually or collectively may execute the instructions to cause the at least one electronic device 1000 to, when the one or more objects identified through the first AI model do not correspond to the one or more objects identified through the second AI model, transmit, to the server 2000, the content image, information corresponding to the one or more objects identified through the first AI model, and information corresponding to the one or more objects identified through the second AI model.

In an example embodiment of the disclosure, the at least one processor 220 individually or collectively may execute the instructions to cause the server 2000 to identify one or more objects from the content image through a third AI model, and extract, from the content image, an incorrect result region corresponding to an object identified differently by the at least one electronic device 1000 and the server 2000.

In an example embodiment of the disclosure, the at least one processor 220 individually or collectively may execute the instructions to cause the server 2000 to generate a training image based on the content image and the incorrect result region and store the training image.

In an example embodiment of the disclosure, the at least one processor 220 individually or collectively may execute the instructions to cause the server 2000 to train models respectively corresponding to the first AI model and the second AI model using the stored training image.

According to an example embodiment of the disclosure, an operation method of the electronic device 1000 is provided.

In an example embodiment of the disclosure, the operation method of the electronic device 1000 may include identifying, based on a content image input thereto, one or more objects through each of a first AI model and a second AI model (S210). In an embodiment of the disclosure, the operation method of the electronic device 1000 may include, when the one or more objects identified through the first AI model do not correspond to the one or more objects identified through the second AI model, transmitting, to a server, the content image, information corresponding to the one or more objects identified through the first AI model, and information corresponding to the one or more objects identified through the second AI model (S220). In an embodiment of the disclosure, the operation method of the electronic device 1000 may include receiving, from the server, information corresponding to an update of at least one of the first AI model or the second AI model, which is obtained using a training image generated based on the content image, the information corresponding to the one or more objects identified through the first AI model, and the information corresponding to the one or more objects identified through the second AI model (S230).

In an example embodiment of the disclosure, the operation method of the electronic device 1000 may include receiving an input corresponding to object identification for each of a plurality of content images (S610). In an embodiment of the disclosure, the operation method of the electronic device 1000 may include, when a resolution of each of the plurality of content images is less than a threshold value, the electronic device 1000 may execute each of the first AI model and the second AI model according to the receiving of the input corresponding to the object identification, and when the resolution of each of the plurality of content images is greater than or equal to the threshold value, execute the first AI model according to the receiving of the input corresponding to the object identification and execute the second AI model 133 based on a defined frequency (S620).

In an example embodiment of the disclosure, the operation method of the electronic device 1000 may include receiving an input corresponding to object identification for each of a plurality of content images (S710). In an embodiment of the disclosure, the operation method of the electronic device 1000 may include executing the first AI model and the second AI model alternately according to the receiving of the input corresponding to the object identification (S720). In an embodiment of the disclosure, the operation method of the electronic device 1000 may include executing both the first AI model and the second AI model when frequencies of execution of the first AI model and the second AI model correspond to a defined frequency (S730).

In an example embodiment of the disclosure, the operation method of the electronic device 1000 may include, when the one or more objects identified through the first AI model do not correspond to the one or more objects identified through the second AI model, storing the content image and the information corresponding to the one or more objects identified through the second AI model (S1210). In an embodiment of the disclosure, the operation method of the electronic device 1000 may include training the first AI model by inputting the information corresponding to the one or more objects identified through the second AI model as a response to object identification in the content image (S1220).

In an example embodiment of the disclosure, the information corresponding to the update of the at least one of the first AI model or the second AI model may include at least one of a model that is obtained by updating the first AI model based on the training image and information corresponding to one or more objects identified from the training image through the server or a model that is obtained by updating the second AI model based on the training image and the information corresponding to the one or more objects identified from the training image through the server.

In an example embodiment of the disclosure, the training image may be based on the content image and the incorrect result region corresponding to the object identified differently by the electronic device 1000 and the server 2000.

In an example embodiment of the disclosure, the training image may correspond to an image obtained by specifying, based on a second feature prompt corresponding to the incorrect result region, a base image based on a first feature prompt corresponding to the remaining region of the content image other than the incorrect result region.

According to an example embodiment of the disclosure, the content image may include a first content image having a first identification difficulty level based on the information corresponding to the one or more objects identified from the content image through the first AI model being the same as information corresponding to one or more objects identified from the content image through an AI model stored in the server, and a second content image having a second identification difficulty level based on the information corresponding to the one or more objects identified from the content image through the second AI model being the same as the information corresponding to the one or more objects identified from the content image through the AI model stored in the server. In an embodiment of the disclosure, the training image may include a first training image corresponding to the first content image having the first identification difficulty level and a second training image corresponding to the second content image having the second identification difficulty level.

In an example embodiment of the disclosure, the operation method of the electronic device 1000 may include receiving, from the server, one of a first type AI model and a second type AI model that are trained from the first AI model respectively based on a first type dataset and a second type dataset having different ratios between the first training image and the second training image. In an embodiment of the disclosure, the operation method of the electronic device 1000 may include transmitting a test result of one of the first type AI model and the second type AI model to the server. In an embodiment of the disclosure, the operation method of the electronic device 1000 may include receiving, from the server, information corresponding to a final model determined from among the first AI model, the first type AI model, and the second type AI model, based on the test result of the one of the first type AI model and the second type AI model. In an embodiment of the disclosure, the operation method of the electronic device 1000 may include updating at least one of the first AI model or the second AI model based on the information corresponding to the final model.

According to an example embodiment of the disclosure, an operation method of the server 2000 is provided.

In an example embodiment of the disclosure, the operation method of the server 2000 may include receiving, from at least one electronic device, a content image and information corresponding to one or more objects identified from the content image through one or more AI models stored in the at least one electronic device (S310).

In an example embodiment of the disclosure, the operation method of the server 200 may include identifying one or more objects from the content image through an AI model stored in the server 2000, and extracting, from the content image, an incorrect result region corresponding to an object identified differently by the at least one electronic device and the server 2000 (S320).

In an example embodiment of the disclosure, the operation method of the server 2000 may include generating a training image based on the content image 1 and the incorrect result region and storing the training image (S330).

In an example embodiment of the disclosure, the operation method of the server 2000 may include training models corresponding to the one or more AI models stored in the at least one electronic device using the stored training image (S340).

In an example embodiment of the disclosure, the operation method of the server 2000 may include generating a base image based on features extracted from the remaining region of the content image other than the incorrect result region (S810).

In an example embodiment of the disclosure, the operation method of the server 2000 may include generating a training image by specifying the base image based on features extracted from the incorrect result region in the content image (S820).

In an example embodiment of the disclosure, the operation method of the server 2000 may include, when information corresponding to one or more objects identified from the content image through a first AI model included in the at least one electronic device is the same as (corresponds to) information corresponding to the one or more objects identified from the content image through the AI model stored in the server 2000, determining an identification difficulty level of the content image as a first identification difficulty level (S910).

In an example embodiment of the disclosure, the operation method of the server 2000 may include, when information corresponding to one or more objects identified from the content image through a second AI model is the same as the information corresponding to the one or more objects identified from the content image through the AI model stored in the server 2000, determining an identification difficulty level of the content image as a second identification difficulty level (S920).

In an example embodiment of the disclosure, the operation method of the server 2000 may include, when a content image corresponding to a training image has the first identification difficulty level, determining an identification difficulty level of the training image as the first identification difficulty level, and when a content image corresponding to a training image has the second identification difficulty level, determining an identification difficulty level of the training image as the second identification difficulty level (S930).

According to an example embodiment of the disclosure, a non-transitory computer-readable recording medium recording medium having recorded thereon a program for performing an operation method of the electronic device 1000 is provided.

According to an example embodiment of the disclosure, a non-transitory computer-readable recording medium recording medium having recorded thereon a program for performing an operation method of the server 2000 is provided.

A non-transitory machine-readable storage medium may be provided in the form of a non-transitory storage medium. In this regard, the 'non-transitory storage medium' storage medium does not include a signal (e.g., an electromagnetic wave) and may be a tangible device, and the term does not differentiate between where data is semi-permanently stored in the storage medium and where the data is temporarily stored in the storage medium. For example, the 'non-transitory storage medium' may include a buffer for temporarily storing data.

According to an embodiment of the disclosure, the operation methods according to various embodiments of the disclosure presented herein may be included in a computer program product when provided. The computer program product may be traded, as a product, between a seller and a buyer. The computer program product may be distributed in the form of a machine-readable storage medium (e.g., compact disc (CD)-ROM)) or distributed (e.g., downloaded or uploaded) on-line via an application store or directly between two user devices (e.g., smartphones). For online distribution, at least a part of the computer program product (e.g., a downloadable app) may be at least transiently stored or temporally generated in a machine-readable storage medium such as a memory of a server of a manufacturer, a server of an application store, or a relay server.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a communication interface comprising communication circuitry;
memory storing a plurality of instructions; and
at least one processor, comprising processing circuitry, operatively coupled to the memory,
wherein the at least one processor individually and/or collectively executes the instructions to cause the electronic device to:
identify, based on a content image input to the electronic device, one or more objects through each of a first artificial intelligence (AI) model and a second AI model,
based on the one or more objects identified through the first AI model not corresponding to the one or more objects identified through the second AI model, transmit, to a server, via the communication interface, the content image, information corresponding to the one or more objects identified through the first AI model, and information corresponding to the one or more objects identified through the second AI model, and
receive, from the server, via the communication interface, information corresponding to an update of at least one of the first AI model or the second AI model, obtained using a training image generated based on the content image, the information corresponding to the one or more objects identified through the first AI model, and the information corresponding to the one or more objects identified through the second AI model.

2. The electronic device of claim 1, wherein:
wherein the at least one processor individually and/or collectively executes the instructions to cause the electronic device to:
receive an input corresponding to object identification for each of a plurality of content images, and
based on a resolution of each of the plurality of content images being less than a threshold value, execute each of the first AI model and the second AI model according to the receiving of the input corresponding to the object identification, and based on the resolution of each of the plurality of content images being greater than or equal to the threshold value, execute the first AI model according to the receiving of the input corresponding to the object identification and execute the second AI model based on a defined frequency.

3. The electronic device of claim 1, wherein:
the at least one processor individually and/or collectively executes the instructions to cause the electronic device to:
receive an input corresponding to object identification for each of a plurality of content images,
execute the first AI model and the second AI model alternately according to the receiving of the input corresponding to the object identification, and
execute both the first AI model and the second AI model based on frequencies of execution of the first AI model and the second AI model corresponding to a defined frequency.

4. The electronic device of claim 1, wherein:
the at least one processor individually and/or collectively executes the instructions to cause the electronic device to:
based on the one or more objects identified through the first AI model not corresponding to the one or more objects identified through the second AI model, store the content image and the information corresponding to the one or more objects identified through the second AI model, and
train the first AI model by inputting the information corresponding to the one or more objects identified through the second AI model in response to the object identification in the content image.

5. The electronic device of claim 1, wherein the information corresponding to the update of the at least one of the first AI model or the second AI model comprises at least one of a model obtained by updating the first AI model based on the training image and information corresponding to one or more objects identified from the training image through the server or a model obtained by updating the second AI model based on the training image and the information corresponding to the one or more objects identified from the training image through the server.

6. The electronic device of claim 1, wherein the training image is based on the content image and an incorrect result region corresponding to an object identified differently by the electronic device and the server.

7. The electronic device of claim 6, wherein the training image corresponds to an image obtained by specifying, based on a second feature prompt corresponding to the incorrect result region, a base image based on a first feature prompt corresponding to a remaining region of the content image other than the incorrect result region.

8. The electronic device of claim 1, wherein:
the content image comprises:
a first content image having a first identification difficulty level based on the information corresponding to the one or more objects identified from the content image through the first AI model being identical to information corresponding to one or more objects identified from the content image through an AI model stored in the server; and
a second content image having a second identification difficulty level based on the information corresponding to the one or more objects identified from the content image through the second AI model being identical to the information corresponding to the one or more objects identified from the content image through the AI model stored in the server, and
the training image comprises:
a first training image corresponding to the first content image having the first identification difficulty level; and
a second training image corresponding to the second content image having the second identification difficulty level.

9. The electronic device of claim 8, wherein:
the at least one processor individually and/or collectively executes the instructions to cause the electronic device to:
receive, from the server, one of a first type AI model and a second type AI model trained from the first AI model respectively based on a first type dataset and a second type dataset having different ratios between the first training image and the second training image, and
transmit a test result of one of the first type AI model and the second type AI model to the server.

10. The electronic device of claim 9, wherein:
wherein the at least one processor individually and/or collectively executes the instructions to cause the electronic device to:
receive, from the server, information corresponding to a final model determined from among the first AI model, the first type AI model, and the second type AI model, based on a test result of one of the first type AI model and the second type AI model, and
update the first AI model based on the received information corresponding to the final model.

11. A method of operating an electronic device, the method comprising:
identifying, based on a content image input to the electronic device, one or more objects through each of a first artificial intelligence (AI) model and a second AI model;
based on the one or more objects identified through the first AI model not corresponding to the one or more objects identified through the second AI model, transmitting, to a server, the content image, information corresponding to the one or more objects identified through the first AI model, and information corresponding to the one or more objects identified through the second AI model; and
receiving, from the server, information corresponding to an update of at least one of the first AI model or the second AI model, obtained using a training image generated based on the content image, the information corresponding to the one or more objects identified through the first AI model, and the information corresponding to the one or more objects identified through the second AI model.

12. The method of claim 11, further comprising:
receiving an input corresponding to object identification for each of a plurality of content images; and
based on a resolution of each of the plurality of content images being less than a threshold value, executing each of the first AI model and the second AI model according to the receiving of the input corresponding to the object identification, and based on the resolution of each of the plurality of content images being greater than or equal to the threshold value, executing the first AI model according to the receiving of the input corresponding to the object identification and executing the second AI model based on a defined frequency.

13. The method of claim 11, further comprising:
receiving an input corresponding to object identification for each of a plurality of content images;
executing the first AI model and the second AI model alternately according to the receiving of the input corresponding to the object identification; and
executing both the first AI model and the second AI model based on frequencies of execution of the first AI model and the second AI model corresponding to a defined frequency.

14. The method of claim 11, further comprising:
based on the one or more objects identified through the first AI model not corresponding to the one or more objects identified through the second AI model, storing the content image and the information corresponding to the one or more objects identified through the second AI model; and
training the first AI model by inputting the information corresponding to the one or more objects identified through the second AI model in response to the object identification in the content image.

15. The method of claim 11, wherein the information corresponding to the update of the at least one of the first AI model or the second AI model comprises at least one of a model obtained by updating the first AI model based on the training image and information corresponding to one or more objects identified from the training image through the server or a model obtained by updating the second AI model based on the training image and the information corresponding to the one or more objects identified from the training image through the server.

16. The method of claim 11, wherein the training image is based on the content image and an incorrect result region corresponding to an object identified differently by the electronic device and the server.

17. The method of claim 16, wherein the training image corresponds to an image obtained by specifying, based on a second feature prompt corresponding to the incorrect result region, a base image based on a first feature prompt corresponding to a remaining region of the content image other than the incorrect result region.

18. The method of claim 11, wherein:
the content image comprises:
a first content image having a first identification difficulty level based on the information corresponding to the one or more objects identified from the content image through the first AI model being identical to information corresponding to one or more objects identified from the content image through an AI model stored in the server; and
a second content image having a second identification difficulty level based on the information corresponding to the one or more objects identified from the content image through the second AI model being identical to the information corresponding to the one or more objects identified from the content image through the AI model stored in the server, and
the training image comprises:
a first training image corresponding to the first content image having the first identification difficulty level; and
a second training image corresponding to the second content image having the second identification difficulty level.

19. The method of claim 18, further comprising:
receiving, from the server, one of a first type AI model and a second type AI model that are trained from the first AI model respectively based on a first type dataset and a second type dataset having different ratios between the first training image and the second training image;
transmitting a test result of one of the first type AI model and the second type AI model to the server;
receiving, from the server, information corresponding to a final model determined from among the first AI model, the first type AI model, and the second type AI model based on a test result of one of the first type AI model and the second type AI model; and
updating at least one of the first AI model or the second AI model based on the information corresponding to the final model.

20. A non-transitory computer-readable recording medium storing instructions that, when executed by at least one processor of an electronic device, cause the electronic device to:
identify, based on a content image input to the electronic device, one or more objects through each of a first artificial intelligence (AI) model and a second AI model,
based on the one or more objects identified through the first AI model not corresponding to the one or more objects identified through the second AI model, transmit, to a server, via the communication interface, the content image, information corresponding to the one or more objects identified through the first AI model, and information corresponding to the one or more objects identified through the second AI model, and
receive, from the server, via the communication interface, information corresponding to an update of at least one of the first AI model or the second AI model, obtained using a training image generated based on the content image, the information corresponding to the one or more objects identified through the first AI model, and the information corresponding to the one or more objects identified through the second AI model.
